(19) United States
(12) Patent Application Publication
(10) Pub. No.: US 2012/0044141 A1
(43) Pub. Date: Feb. 23, 2012

(54) INPUT SYSTEM, INPUT METHOD, COMPUTER PROGRAM, AND RECORDING MEDIUM

(76) Inventors: Hiromu Ueshima, Shiga (JP); Keiichi Yasumura, Shiga (JP)

(21) Appl. No.: 12/993,204

(22) PCT Filed: Sep. 26, 2008
(86) PCT No.: PCT/JP2008/002686

§ 371 Date: May 14, 2011

(30) Foreign Application Priority Data
May 23, 2008 (JP) 2008-136108

(51) Int. Cl. G06F 3/033

(52) U.S. Cl. 345/158

(57) ABSTRACT

A position of a cursor 67 is controlled so that positions of retroreflective sheets 17L and 17R in real space coincides with positions of cursors 67 in a video image projected onto a screen 21, on the screen 21 in the real space. A processor 23 can recognize positions of the retroreflective sheets 17 on the video image via the cursors 67. Hence, the player 15 can perform input to the processor 23 by moving the retroreflective sheets 17L and 17R on the video image projected onto the screen 21 and indicating directly desired locations on the video image by the retroreflective sheets 17L and 17R.

### TECHNICAL FIELD

The present invention relates to an input system for performing input on the basis of an image of a subject reflected in a photographed picture, and the related arts.

### BACKGROUND ART

Patent Document 1 discloses a golf game system of the present applicant. The golf game system includes a game machine and a golf-club-type input device. A housing of the game machine houses a photographing unit. The photographing unit comprises an image sensor and infrared light emitting diodes. The infrared light emitting diodes intermittently emit infrared light to a predetermined area in front of the photographing unit. Accordingly, the image sensor intermittently photographs a reflecting-member of the golf-club-type input device which is moving in the area. The velocity and the like can be calculated as the inputs given to the game machine by processing the stroboscopic images of the reflecting member.

[Patent Document 1] Japanese Unexamined Patent Application Publication No. 2004-85524

### DISCLOSURE OF THE INVENTION

### Problem to be Solved by the Invention

It is an object of the present invention to provide a novel input system and the related arts capable of performing input on the basis of an image of a subject reflected in a photographed picture.

### Solution of the Problem

In accordance with a first aspect of the present invention, an input system comprising: a video image generating unit operable to generate a video image; a controlling unit operable to control the video image; a projecting unit operable to project the video image onto a screen placed in real space; and a photographing unit operable to photograph a subject which is in the real space and operated by a player on the screen, wherein the controlling unit including: an analyzing unit operable to obtain a position of the subject on the basis of a photographed picture obtained by the photographing unit; and a cursor controlling unit operable to make a cursor follow the subject on the basis of the position of the subject obtained by the analyzing unit, and wherein the cursor controlling unit including: a correcting unit operable to correct a position of the cursor so that the position of the subject in the real space coincides with the position of the cursor in the projected video image, on the screen in the real space.

In accordance with this configuration, the player can perform the input to the controlling unit by moving the subject on the video image projected onto the screen and indicating directly the desired location in the video image by the subject. Because, on the screen in the real space, the position of the subject in the real space coincides with the position of the cursor in the projected video image, and therefore the controlling unit can recognize, through the cursor, the position in the video image on which the subject is placed.

Incidentally, in the present specification and claims, the term “coincide” includes the term “completely coincide” and the term “nearly coincide”.

In accordance with a second aspect of the present invention, an input system comprising: a video image generating unit operable to generate a video image; and a controlling unit operable to control the video image; wherein the controlling unit including: an analyzing unit operable to obtain a position of a subject on the basis of a photographed picture obtained by a photographing unit which photographs the subject in real space, the subject being operated by a player on a screen placed in the real space, and a cursor controlling unit operable to make a cursor follow the subject on the basis of the position of the subject obtained by the analyzing unit, and wherein the cursor controlling unit including: a correcting unit operable to correct a position of the cursor so that the position of the subject in the real space coincides with the position of the cursor in the video image projected onto the screen, on the screen in the real space.

In accordance with this configuration, the same advantage as the input system according to the first aspect can be gotten.

The input systems according to the above first and second aspects, further comprising: a marker image generating unit operable to generate a video image for calculating a parameter which is used in performing the correction, and arranges a predetermined marker at a predetermined position in the video image; a correspondence position calculating unit operable to correlate the photographed picture obtained by the photographing unit with the video image generated by the marker image generating unit, and calculate a correspondence position, which is a position in the video image corresponding to a position of an image of the subject in the photographed picture; and a parameter calculating unit operable to calculate the parameter which the correcting unit uses in correcting on the basis of the predetermined position at which the predetermined marker is arranged, and the correspondence position when the subject is put on the predetermined marker projected onto the screen.

In accordance with this configuration, it is possible to simply obtain the parameter for the correction only by making the player put the subject on the marker projected onto the screen.

In these input systems, the marker image generating unit arranges a plurality of the predetermined markers at a plurality of the predetermined positions in the video image, or arranges the predetermined marker at the different predetermined positions in the video image by changing time.

In accordance with this configuration, the subject(s) is(are) put on the marker(s) which are arranged at the plurality of the different locations, and thereby the parameter for the correction is obtained, and therefore it is possible to more improve the accuracy of the correction.

For example, the marker image generating unit arranges the four predetermined markers at four corners in the video image, or arranges the predetermined marker at four corners in the video image by changing time.

In accordance with this configuration, it is possible to obtain the parameter for the correction with high accuracy while using the relatively-small number of the markers.

In this case, further, the marker image generating unit arranges the single predetermined marker at a center of the video image in which the four predetermined markers are arranged, or at a center of a different video image.

In accordance with this configuration, it is possible to obtain the parameter for the correction with higher accuracy.

In the above input systems, the correction by the correcting unit includes keystone correction.

In accordance with this configuration, even the case where the photographing unit, which is installed so that the optical axis is oblique with respect to the screen, photographs the subject on the screen, moreover the movement of the subject is analyzed on the basis of the photographed picture, and still moreover the cursor which moves in conjunction therewith is generated, the movement of the subject operated by the player coincides with or nearly coincides with the movement of the cursor. Because, it is possible to eliminate the trapezoidal distortion as much as possible by the keystone correction. As the result, the player can perform the input while suppressing the sense of the incongruity as much as possible.

In the above input systems, the photographing unit is installed in front of the player, and photographs from such a location as to look down at the subject, and wherein in a case where the subject moves from a back to a front when seen from the photographing unit, the cursor controlling unit determines the position of the cursor so that the projected cursor moves from a back to a front when seen from the photographing unit, in a case where the subject moves from the front to the back when seen from the photographing unit, the cursor controlling unit determines the position of the cursor so that the projected cursor moves from the front to the back when seen from the photographing unit, in a case where the subject moves from a right to a left when seen from the photographing unit, the cursor controlling unit determines the position of the cursor so that the projected cursor moves from a right to a left when seen from the photographing unit, and in a case where the subject moves from the left to the right when seen from the photographing unit, the cursor controlling unit determines the position of the cursor so that the projected cursor moves from the left to the right when seen from the photographing unit.

In accordance with this configuration, even the case (hereinafter referred to as the “downward case”) where the photographing is performed from such a location as to look down at the subject in front of the player, the moving direction of the subject operated by the player coincides with the moving direction of the cursor on the screen sensuously, and therefore it is possible to perform the input to the controlling unit easily while suppressing the stress in inputting as much as possible.

In passing, in the case (hereinafter referred to as the “upward case”) where the photographing is performed from such a location as to look up at the subject in front of the player, usually, if the subject moves from the back to the front when seen from the photographing unit, the position of the cursor is determined so that the cursor moves upward when the player looks at the video image displayed on the screen which is vertically installed, and if the subject moves from the front to the back when seen from the photographing unit, the position of the cursor is determined so that the cursor moves downward when the player looks at the video image displayed on the screen which is vertically installed.

However, in the downward case, if the cursor is controlled by the same algorithm as the upward case, if the subject moves from the back to the front when seen from the photographing unit, the result is that the position of the cursor is determined so that the cursor moves downward when the player looks at the video image displayed on the screen which is vertically installed, and if the subject moves from the front to the back when seen from the photographing unit, the result is that the position of the cursor is determined so that the cursor moves upward when the player looks at the video image displayed on the screen. In this case, the moving direction of the subject operated by the player does not coincide with the moving direction of the cursor on the screen sensuously. Hence, since the input is fraught with stress, it is not possible to perform the input smoothly.

The reason for causing such fact is that a vertical component of an optical axis vector of the photographing unit faces the vertical downward direction in the downward case, and therefore the up and down directions of the photographing unit do not coincide with the up and down directions of the player.

Also, because, in many cases, the optical axis vector of the photographing unit does not have the vertical component (i.e., the photographing surface is parallel to the vertical plane), or the vertical component of the optical axis vector faces vertically upward, the photographing unit is installed so that the up and down directions of the photographing unit coincide with the up and down directions of the player, and there is the habituation of such usage.

In this case, the direction which faces the starting point from the ending point of the vertical component of the optical axis vector of the photographing unit corresponds to the downward direction of the photographing unit, and the direction which faces the ending point from the starting point thereof corresponds to the upward direction of the photographing unit. Also, the direction which faces the head from the foot of the player corresponds to the upward direction of the player, and the direction which faces the foot from the head thereof corresponds to the downward direction of the player.

In the above input systems, the cursor is displayed so that the player can visibly recognize it.

In accordance with this configuration, the player 15 can confirm that the projected cursor coincides with the retroreflective sheet, and recognize that the system is normal.

In the above input systems, the cursor is given as hypothetical one, and is not displayed.

In passing, even the case where the player can not recognize the cursor visibly, if the controlling unit can recognize the position of the cursor, the controlling unit can recognize where the retroreflective sheet is placed on the projection video image. Incidentally, in this case, the cursor may be made non-display, or the transparent cursor may be displayed. Also, even if the cursor is not displayed, the play of the player is hardly affected.

In accordance with a third aspect of the present invention, an input system comprising: a video image generating unit operable to generate a video image including a cursor; a controlling unit operable to control the video image; and a photographing unit configured to be installed so that an optical axis is oblique with respect to a plane to be photographed, and photograph a subject on the plane to be photographed, wherein the controlling unit including: an analyzing unit operable to obtain a position of the subject on the basis of a photographed picture obtained by the photographing unit; a keystone correction unit operable to apply keystone correction to the position of the subject obtained by the analyzing unit; and a cursor controlling unit operable to make the cursor follow the subject on the basis of a position of the subject after the keystone correction.

In accordance with this configuration, even the case where the photographing unit, which is installed so that the optical axis is oblique with respect to the plane to be photographed, photographs the subject on the plane to be photographed, moreover the movement of the subject is analyzed on the basis of the photographed picture, and still moreover the cursor which moves in conjunction therewith is generated, the movement of the subject operated by the player coincides with or nearly coincides with the movement of the cursor. Because, the keystone correction is applied to the position of the subject which defines the position of the cursor. As the result, the player can perform the input while suppressing the sense of the incongruity as much as possible.

In accordance with a fourth aspect of the present invention, an input system comprising: a video image generating unit operable to generate a video image including a cursor; and a controlling unit operable to control the video image, wherein the controlling unit including: an analyzing unit operable to obtain a position of a subject on the basis of a photographed picture obtained by a photographing unit which is installed so that an optical axis is oblique with respect to a plane to be photographed, and photographs the subject on the plane to be photographed, a keystone correction unit operable to apply keystone correction to the position of the subject obtained by the analyzing unit; and a cursor controlling unit operable to make the cursor follow the subject on the basis of a position of the subject after the keystone correction.

In accordance with this configuration, the same advantage as the input system according to the third aspect can be gotten.

In the input systems according to the above third and fourth aspects, the keystone correction unit applies the keystone correction depending on a distance between the subject and the photographing unit.

As the distance between the subject and the photographing unit is longer, the trapezoidal distortion of the image of the subject reflected in the photographed picture is larger. Accordingly, in accordance with the present invention, it is possible to perform the appropriate keystone correction depending on the distance.

In these input systems, the keystone correction unit including: a horizontally-correction unit operable to correct a horizontal coordinate of the cursor so that the distance between the subject and the photographing unit is positively correlated with a moving distance of the cursor in a horizontal direction.

In accordance with this configuration, it is possible to correct the trapezoidal distortion in the horizontal direction.

In the input systems according to the above third and fourth aspects, the keystone correction unit including: a vertically-correction unit operable to correct a vertical coordinate of the cursor so that the distance between the subject and the photographing unit is positively correlated with a moving distance of the cursor in a vertical direction.

In accordance with this configuration, it is possible to correct the trapezoidal distortion in the vertical direction.

In the input systems according to the above third and fourth aspects, the photographing unit photographs from such a location as to look down at the subject.

In accordance with this configuration, the player can operate the cursor by moving the subject on the floor surface. For example, the player wears the subject on the foot and moves it. In this case, it is possible to apply to the game using the foot, the exercise using the foot, and so on.

The input systems according to the above first to fourth aspects, further comprising: a light emitting unit operable to intermittently irradiate the subject with light, wherein the subject including: a retroreflective member configured to reflect received light retroreflectively, wherein the analyzing unit obtains the position of the subject on the basis of a differential picture between a photographed picture at time when the light emitting unit irradiates the light and a photographed picture at time when the light emitting unit does not irradiate the light.

In accordance with this configuration, it is possible to eliminate, as much as possible, noise of light other than the light reflected from the retroreflective member, so that only the retroreflective member can be detected with a high degree of accuracy.

In the input systems according to the above first to fourth aspects, the controlling unit including: an arranging unit operable to arrange a predetermined image in the video image; and

a determining unit operable to determine whether or not the cursor comes in contact with or overlaps with the predetermined image.

In accordance with this configuration, the predetermined image can be used as an icon for issuing a command, various items in a video game, and so on.

In these input systems, the determining unit determines whether or not the cursor continuously overlaps with the predetermined image during a predetermined time.

In accordance with this configuration, the input is not accepted immediately when the contact and so on occurs, the input is accepted only after the contact and so on continues during the predetermined time, and thereby it is possible to prevent the erroneous input.

In the above input systems, the arranging unit moves the predetermined image, and wherein the determining unit determines whether or not the cursor comes in contact with or overlaps with the moving predetermined image under satisfaction of a predetermined requirement.

In accordance with this configuration, it is not sufficient that the player merely operates the subject so that the cursor comes in contact with the predetermined image, and the player has to operate the subject so that the predetermined requirement is also satisfied. As the result, it is possible to improve the game element and the difficulty level.

In accordance with a fifth aspect of the present invention, an input method comprising the steps of: generating a video image; and controlling the video image, wherein the step of controlling including; an analysis step of obtaining a position of a subject on the basis of a photographed picture obtained by a photographing unit which photographs the subject in real space, the subject being operated by a player on a screen placed in the real space; and a cursor control step of making a cursor follow the subject on the basis of the position of the subject obtained by the analysis step, wherein the cursor control step including: a correction step of correcting a position of the cursor so that the position of the subject in the real space coincides with the position of the cursor in the video image projected onto the screen, on the screen in the real space.

In accordance with this configuration, the same advantage as the input system according to the first aspect can be gotten.

In accordance with a sixth aspect of the present invention, an input method comprising the steps of: generating a video image including a cursor; and controlling the video image; wherein the step of controlling including: an analysis step of obtaining a position of a subject on the basis of a photographed picture obtained by a photographing unit which is installed so that an optical axis is oblique with respect to a plane to be photographed, and photographs the subject on the plane to be photographed, a keystone correction step of applying keystone correction to the position of the subject obtained by the analysis step; and a cursor control step of making the cursor follow the subject on the basis of a position of the subject after the keystone correction.

In accordance with this configuration, the same advantage as the input system according to the third aspect can be gotten.

In accordance with a seventh aspect of the present invention, a computer program enables a computer to perform the input method according to the above fifth aspect.

In accordance with this configuration, the same advantage as the input system according to the first aspect can be gotten.

In accordance with an eighth aspect of the present invention, a computer program enables a computer to perform the input method according to the above sixth aspect.

In accordance with this configuration, the same advantage as the input system according to the third aspect can be gotten.

In accordance with a ninth aspect of the present invention, a computer readable recording medium embodies the computer program according to the above seventh aspect.

In accordance with this configuration, the same advantage as the input system according to the first aspect can be gotten.

In accordance with a tenth aspect of the present invention, a computer readable recording medium embodies the computer program according to the above eighth aspect.

In accordance with this configuration, the same advantage as the input system according to the third aspect can be gotten.

In the input method according to the above fifth aspect, in the computer program according to the above seventh aspect, and in the recording medium according to the above ninth aspect, the cursor is displayed so that the player can visibly recognize it. On the other hand, the cursor may be given as hypothetical one, and is not displayed.

In the present specification and claims, the recording medium includes, for example, a flexible disk, a hard disk, a magnetic tape, a magneto-optical disk, a CD (including a CD-ROM, a Video-CD), a DVD (including a DVD-Video, a DVD-ROM, a DVD-RAM), a ROM cartridge, a RAM memory cartridge with a battery backup unit, a flash memory cartridge, a nonvolatile RAM cartridge, and so on.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the entire configuration of an entertainment system in accordance with a first embodiment of the present invention.

FIG. 2 is a schematic view showing the entertainment system of FIG. 1.

FIG. 3 is a view showing the electric configuration of the entertainment system of FIG. 1.

FIG. 4 is an explanatory view for showing a photographing range of a camera unit 5 of FIG. 1.

FIG. 5 is an explanatory view for showing association among a video image generated by an information processing apparatus 3 of FIG. 1, a picture obtained by the camera unit 5, and an effective photographing range 31 of FIG. 4.

FIG. 6 is an explanatory view for showing necessity of calibration.

FIG. 7 is an explanatory view for showing necessity of calibration.

FIG. 8 is an explanatory view for showing necessity of calibration.

FIG. 9 is a view for showing an example of a calibration screen.

FIG. 10 is an explanatory view for showing a method of deriving a reference magnification which is used in performing keystone correction.

FIG. 11 is an explanatory view for showing a method of correcting the reference magnification derived in FIG. 10.

FIG. 12 is an explanatory view for showing a method of deriving a reference gradient SRUX for correcting a reference magnification PRUX of an x coordinate in a first quadrant q1.

FIG. 13 is an explanatory view for showing a method of deriving a reference gradient SRUY for correcting a reference magnification PRUY of a y coordinate in a first quadrant q1.

FIG. 14 is an explanatory view for showing a method of correcting the reference magnification PRUX of the x coordinate in the first quadrant q1 by using the reference gradient SRUX.

FIG. 15 is an explanatory view for showing a method of correcting the reference magnification PRUY of the y coordinate in the first quadrant q1 by using the reference gradient SRUY.

FIG. 16 is a view for showing an example of a mode selection screen 61 projected onto a screen 21 of FIG. 1.

FIG. 17 is a view for showing an example of a game selection screen 71 projected onto the screen 21 of FIG. 1.

FIG. 18 is a view for showing an example of a whack-a-mole screen 81 projected onto the screen 21 of FIG. 1.

FIG. 19 is a view for showing an example of a free-kick screen 101 projected onto the screen 21 of FIG. 1.

FIG. 20 is a view for showing an example of a one-leg-jump screen 111 projected Onto the screen 21 of FIG. 1.

FIG. 21 is a view for showing an example of a both-leg-jump screen 121 projected onto the screen 21 of FIG. 1.

FIG. 22 is a view for showing an example of a one-leg-stand screen projected onto the screen 21 of FIG. 1.

FIG. 23 is a flow chart showing preprocessing of a processor 23 of FIG. 3.

FIG. 24 is a flow chart showing a photographing process of step S3 of FIG. 23.

FIG. 25 is a flow chart showing a coordinate calculating process of step S5 of FIG. 23.

FIG. 26 is a flow chart showing the overall process of the processor 23 of FIG. 3.

FIG. 27 is a flow chart showing a keystone correction process of step S105 of FIG. 26.

FIG. 28 is a flow chart showing a first example of a game process of step S109 of FIG. 26.

FIG. 29 is a flow chart showing a second example of a game process of step S109 of FIG. 26.

FIG. 30 is a flow chart showing a third example of a game process of step S109 of FIG. 26.

FIG. 31 is a flow chart showing a fourth example of a game process of step S109 of FIG. 26.

FIG. 32 is a flow chart showing a fifth example of a game process of step S109 of FIG. 26.

FIG. 33 is a view showing the electric configuration of an entertainment system in accordance with a second embodiment of the present invention.

FIG. 34 is an explanatory view for showing keystone correction to a horizontal coordinate.

FIG. 35 is an explanatory view for showing keystone correction to a vertical coordinate.

FIG. 36 is a flow chart showing a coordinate calculating process of step S103 of FIG. 26 in accordance with the second embodiment.

FIG. 37 is a flow chart showing a keystone correction process of step S105 of FIG. 26 in accordance with the second embodiment.

### EXPLANATION OF REFERENCES

1 . . . entertainment apparatus, 3 . . . information processing apparatus, 5 . . . camera unit, 11 . . . projector, 21 . . . screen, 17L and 17R . . . retroreflective sheet, 7 . . . infrared light emitting diode, 27 . . . image sensor, 23 . . . processor, 25 . . . external memory, 67L and 67R . . . cursor, 63, 65, 73, 75, 77, 91, 103, 113, 123 and 155 . . . object (predetermined image), and 200 . . . television monitor.

### BEST MODE FOR CARRYING OUT THE INVENTION

In what follows, an embodiment of the present invention will be explained in conjunction with the accompanying drawings. Meanwhile, like references indicate the same or functionally similar elements throughout the drawings, and therefore redundant explanation is not repeated.

In embodiments, while entertainment systems are described, it will be obvious in the descriptions thereof that the respective entertainment systems function as an input system.

### First Embodiment

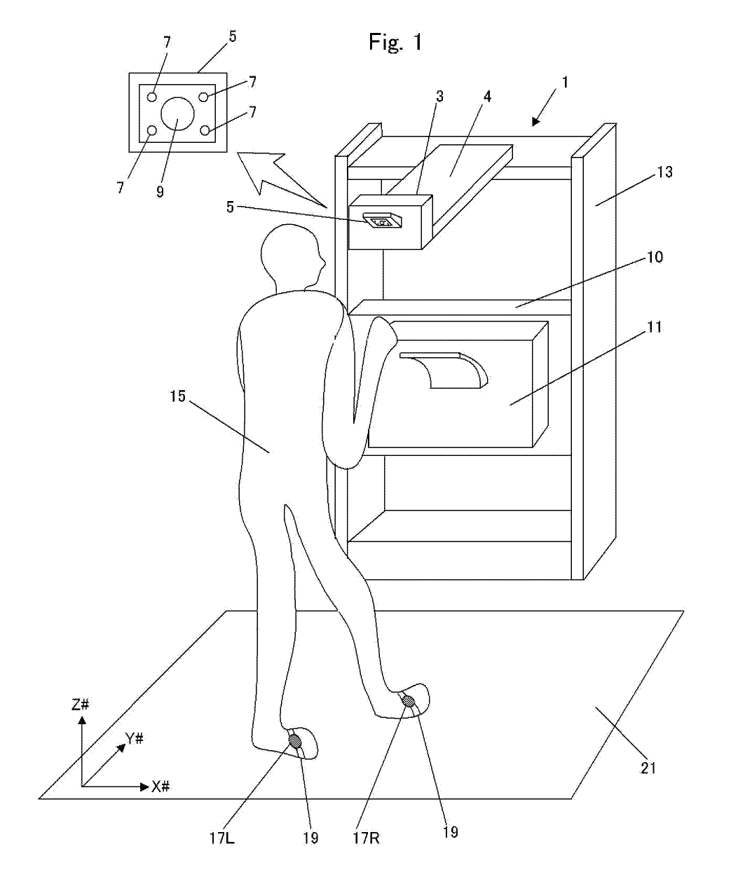

FIG. 1 is a view showing the entire configuration of an entertainment system in accordance with the first embodiment of the present invention. Referring to FIG. 1, the entertainment system is provided with an entertainment apparatus 1, a screen 21, and retroreflective sheets (retroreflective members) 17L and 17R which reflect received light retroreflectively.

In the following description, the retroreflective sheets 17L and 17R are referred to simply as the retroreflective sheets 17 unless it is necessary to distinguish them.

A player wears the retroreflective sheet 17L on an instep of a left foot by a rubber band 19, and wears the retroreflective sheet 17R on an instep of a right foot by a rubber band 19. A screen (e.g., white) is placed on a floor surface (a horizontal plane) in front of the entertainment apparatus 1. The player 15 plays on this screen 21 while moving the feet on which the retroreflective sheets 17L and 17R are worn.

The entertainment apparatus 1 includes a rack 13 installed upright on the floor surface. The rack 13 is equipped with a base member 10 which is arranged in a roughly central position of the rack 13 and almost parallel to a vertical plane. A projector 11 is mounted on the base member 10. The projector 11 projects a video image generated by an information processing apparatus 3 onto the screen 21. The player 15 moves the retroreflective sheets 17L and 17R to desired positions by moving the feet while looking at the projected video image.

Also, the rack 13 is equipped with a base member 4 which is arranged in an upper position of the rack 13 and protrudes toward the player 15. The information processing apparatus 3 is attached to the end of the base member 4. The information processing apparatus 3 includes a camera unit 5. The camera, unit 5 is mounted on the information processing apparatus 3 so as to look down at the screen 21, and the retroreflective sheets 17L and 17R, and photographs the retroreflective sheets 17L and 17R which are operated by the player 15. The camera unit 5 includes an infrared light fitter 9 through which only infrared light is passed, and four infrared light emitting diodes 7 which are arranged around the infrared light filter 9. An image sensor 27 as described below is disposed behind the infrared light filter 9.

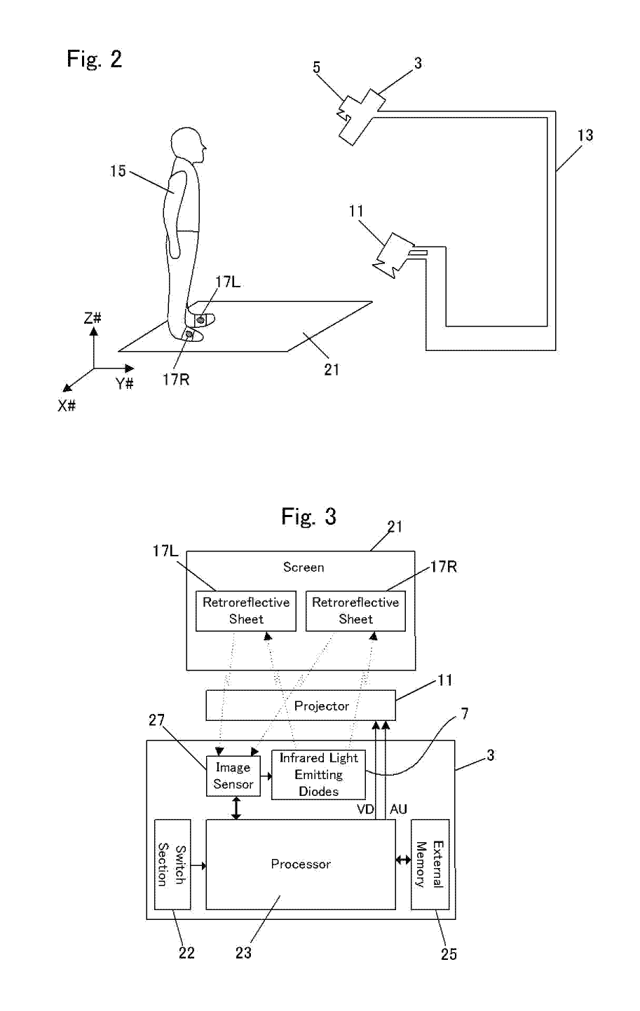

FIG. 2 is a schematic view showing the entertainment system of FIG. 1. Referring to FIG. 2, the camera unit 5 is disposed so as to protrude toward the player 15 more than the projector 11 in the side view. The camera unit 5 is disposed above the screen 21 and views the screen 21, and the retroreflective sheets 17L and 17R diagonally downward ahead. The projector 11 is disposed below the camera unit 5.

FIG. 3 is a view showing the electric configuration of the entertainment system of FIG. 1. Referring to FIG. 3, the information processing apparatus 3 is provided with a processor 23, an external memory 25, an image Sensor 27, infrared light emitting diodes 7, and a switch unit 22. Although not shown in the figure, the switch unit 22 includes an enter key, a cancel key, and arrow keys. Incidentally, the image sensor 27 constitutes the camera unit 5 together with the infrared light emitting diodes 7 and the infrared light filter 9.

The processor 23 is coupled to the external memory 25. The external memory 25, for example, is provided with a flash memory, a ROM, and/or a RAM. The external memory 23 includes a program area, an image data area, and an audio data area. The program area stores control programs for making the processor 23 execute various processes (the processes as illustrated in the flowcharts as described below). The image data area stores image data which is requited in order to generate the video signal VD. The audio data area stores audio data for guidance, sound effect, and so on. The processor 23 executes the control programs in the program area, reads the image data in the image data area and the audio data in the audio data area, processes them, and generates the video signal (video image) VD and the audio signal AU. The video signal VD and the audio signal AU are supplied to the projector 11.

Although not shown in the figure, the processor 23 is provided with various function blocks such as a CPU (central processing unit), a graphics processor, a sound processor, and a DMA controller, and in addition to this, includes an A/D converter for receiving analog signals, an input/output control circuit for receiving input digital signals such as key manipulation signals and infrared signals and giving the output digital signals to external devices, an internal memory, and so forth.

The CPU performs the control programs stored in the external memory 25. The digital signals from the A/D converter and the digital signals from the input/output control circuit are given to the CPU, and the CPU performs the required operations depending on those signals in accordance with the control programs. The graphics processor applies graphics processing required by the operation result of the CPU to the image data stored in the external memory 25 to generate the video signal VD. The sound processor applies sound processing required by the operation result of the CPU to the audio data stored in the external memory 25 to generate the audio signal AU corresponding to the sound effect and so on. For example, the internal memory is a RAM, and is used as a working area, a counter area, a register area, a temporary data area, a flag area and/or the like area.

For example, the image sensor 27 is a CMOS image sensor with 64 pixels times 64 pixels. The image sensor 27 operates under control of processor 23. The particularity is as follows. The image sensor 27 drives the infrared light emitting diodes 7 intermittently. Accordingly, the infrared light emitting diodes 7 emit the infrared light intermittently. As the result, the retroreflective sheets 17L and 17R are intermittently irradiated with the infrared light. The image sensor 27 photographs the retroreflective sheets 17L and 17R at the respective times when the infrared light is emitted and when the infrared light is not emitted. Then, the image sensor 27 generates the differential picture signal between the picture signal at the time when the infrared light is emitted and the picture signal at the time when the infrared light is not emitted to output the processor 23. It is possible to eliminate, as much as possible, noise of light other than the light reflected from the retroreflective sheets 17L and 17R by obtaining the differential picture signal, so that only the retroreflective sheets 17L and 17R can be detected with a high degree of accuracy. That is, only the retroreflective sheets 17L and 17R are reflected in the differential picture.

The video signal VD generated by the processor 23 contains two cursors 67L and 67R (as described below). The two cursors 67L and 67R correspond to the detected retroreflective sheets 17L and 17R respectively. The processor 23 makes the two cursors 67L and 67R follow the retroreflective sheets 17L and 17R respectively.

In what follows, the cursors 67L and 67R are generally referred to as the “cursors 67” in the case where they need not be distinguished.

The projector 11 outputs the sound corresponding to the audio signal AU given from the processor 23 from a speaker (not shown in the figure). Also, the projector 11 projects the video image based on the video signal VD given from the processor 23 onto the screen 21.

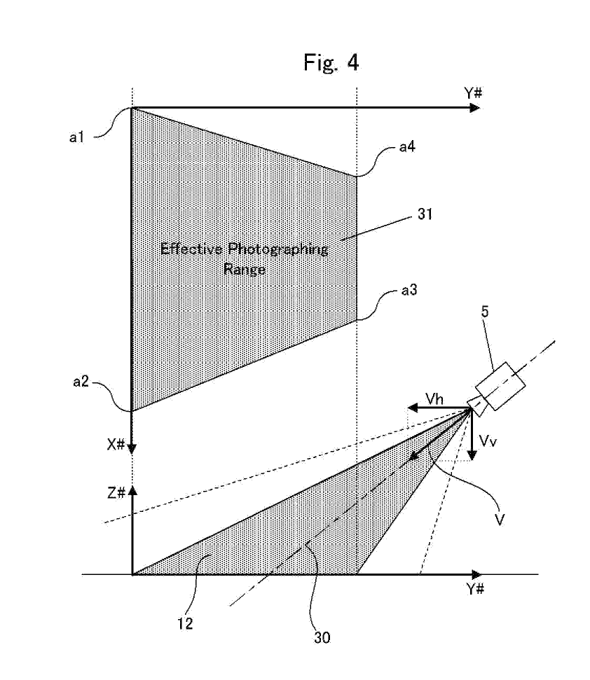

FIG. 4 is an explanatory view for showing a photographing range of the camera unit 5 of FIG. 1. Referring to FIG. 4, a three dimensional orthogonal coordinate system is defined in real space, and a Y# axis is set along a horizontal line, a Z# axis is set along a vertical line, and an X# axis is an axis perpendicular to them. A horizontal plane is formed by the X# axis and Y# axis. A positive direction of the Z# axis corresponds to a vertical upward direction, a positive direction of the Y# axis corresponds to a direction from the screen 21 toward the entertainment apparatus 1, and a positive direction of the X# corresponds to a rightward direction for an observer directed to the positive direction of the Y# axis. Also, origin is a vertex a1 of the effective photographing range 31.

A horizontal component Vh of an optical axis vector V of the image sensor 27 of the camera unit 5 faces the negative direction of the Y# axis, and a vertical component Vv thereof faces the negative direction of the Z# axis. Because, the camera unit 5 is installed so as to look down at the screen 21, and the retroreflective sheets 17L and 17R. Incidentally, the optical axis vector V is a unit vector along an optical axis 30 of the image sensor 27.

The retroreflective sheets 17L and 17R are an example of a subject of the camera unit 5. Also, the screen 21, onto which the video image is projected, is photographed by the camera unit 5 (is not, however, reflected in the differential picture), and therefore the screen 21 is referred to as a plane to be photographed. Also, although the screen 21 is dedicated, a floor itself may be used as a screen if the floor surface is flat and it is possible to easily recognize contents of the video image projected thereon. In this case, the floor surface is the plane to be photographed.

By the way, an effective scope 12 of the photographing by the image sensor 27 is a predetermined angle range centered on the optical axis 30 in the side view. Also, the image sensor 27 looks down at the screen 21 from an oblique direction. Accordingly, the effective photographing range 31 of the image sensor 27 has a trapezoidal shape in the plane view. Reference symbols a1, a2, a3, and a4 are respectively assigned to the four vertices of the effective photographing range 31.

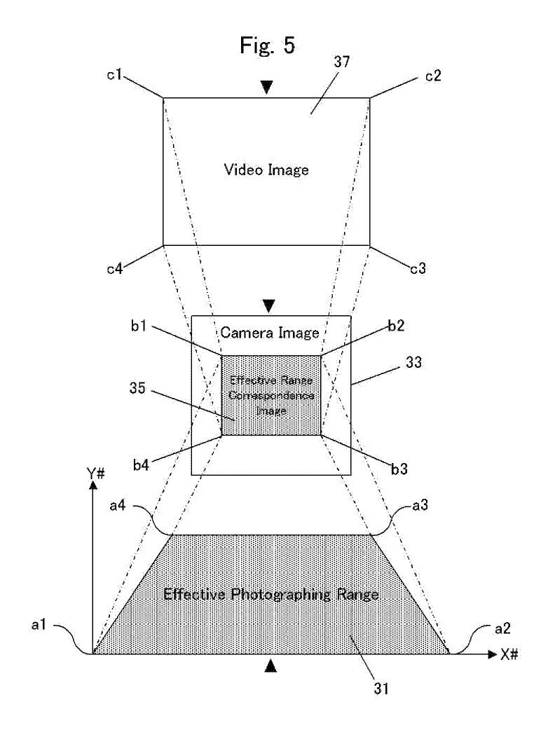

FIG. 5 is an explanatory view for showing association among the video image (rectangle) generated by the information processing apparatus 3 of FIG. 1, the picture (rectangle) obtained by the camera unit 5, and the effective photographing range 31 (trapezoid) of FIG. 4. Referring to FIG. 5, the effective photographing range 31 corresponds to a predetermined rectangular area (hereinafter referred to as the “effective range correspondence image”) 35 in the differential picture (hereinafter referred to as the “camera image”) 33 obtained by the image sensor 27. Specifically, vertices a1 to a4 of the effective photographing range 31 correspond to vertices b1 to b4 of the effective range correspondence image 35 respectively. Accordingly, the retroreflective sheets 17 in the effective photographing range 31 are reflected in the effective range correspondence image 35. Also, the effective range correspondence image 35 corresponds to the video image 37 which is generated by the processor 23. Specifically, the vertices b1 to b4 of the effective range correspondence image 35 correspond to vertices c1 to c4 of the video image 37 respectively. Accordingly, in the present embodiment, the video image contains the cursors 67 which follow the retroreflective sheets 17, and the cursors 67 is located at the positions in the video image corresponding to the positions of the images of the retroreflective sheets 17 reflected in the effective range correspondence image 35. Incidentally, in the video image 37, the effective range correspondence image 35, and the effective photographing range 31, the upper side c1-c2, the upper side b1-b2, and the lower base a1-a2, which are indicated by the black triangles, correspond to one another.

By the way, in the present embodiment, it is required to adjust or correct the position of the cursor 67, i.e., perform calibration so that the position of the retroreflective sheet (subject) 17 in the real space coincide with the position of the cursor 67 contained in the projected video image, on the screen 21 in the real space. In this case, the calibration includes keystone correction. In what follows, this point will be described specifically.

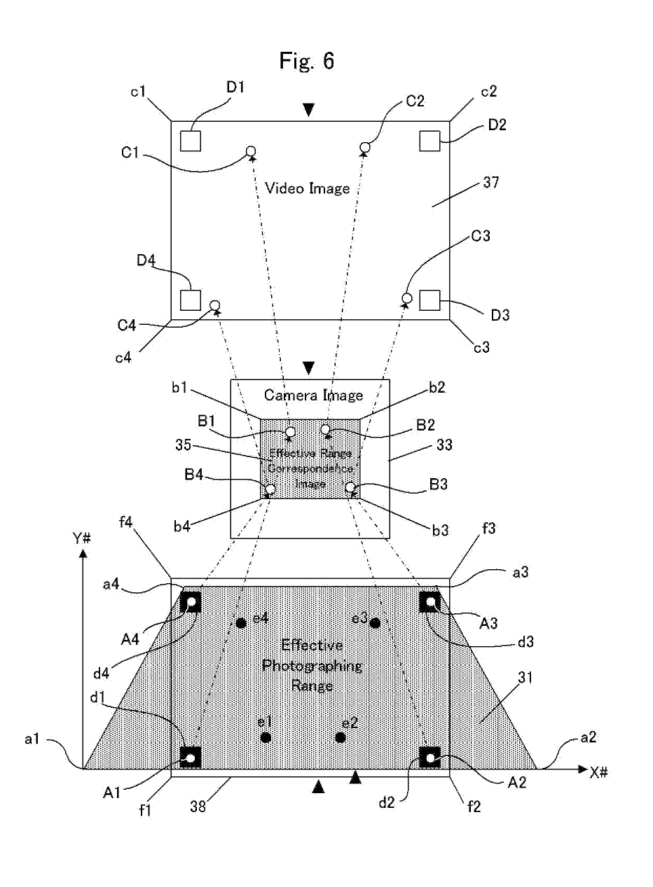

FIGS. 6 to 8 are explanatory views for showing necessity of the calibration. Referring to FIG. 6, the rectangular video image 37 generated by the processor 23 is projected onto the screen 21 by the projector 11. The video image projected onto the screen 21 is referred to as the “projection video image 38”. It is assumed that keystone correction is already applied to the projection video image 38 by the projector 11.

Incidentally, in FIG. 6, it is assumed that the generated video image 37 is projected onto the screen as it is without performing inversion operation and so on. Accordingly, the vertices c1 to c4 of the video image 37 correspond to vertices f1 to f4 of the projection video image 38 respectively. Incidentally, in FIG. 6, in the video image 37, the effective range correspondence image 35, the effective photographing range 31, and the projection video image 38, the upper side c1-c2, the upper side b1-b2, the lower base a1-a2, and the lower side f1-f2, which are indicated by the black triangles, correspond to one another. Images D1 to D4 of four corners of the video image 37 are projected as images d1 to d4 of the projection video image 38 respectively. Incidentally, the images D1 to D4 do not depend on the camera image 33. Therefore, the images d1 to d4 do not depend on the camera image 33 also.

Retroreflective sheets A1 to A4 are respectively arranged so as to overlap with the images d1 to d4 by which the respective vertices of the rectangle are formed. However, since trapezoidal distortion occurs, the mages B1 to B4 of the retroreflective sheets A1 to A4 form respective vertices of a trapezoid in the effective range correspondence image 35. The trapezoidal distortion occurs because the image sensor 27 photographs the screen 21 and the retroreflective sheets A1 to A4 which are horizontally located diagonally downward ahead. Incidentally, the retroreflective sheets A1 to A4 correspond to the images B1 to B4 respectively.

Also, images C1 to C4 are located in the video image 37 so as to correspond to the images B1 to B4 of the retroreflective sheets A1 to A4 reflected in the effective range correspondence image 5 respectively. Thus, the images C1 to C4 in the video image 37 are projected as the images e1 to e4 in the projection video image 38 respectively.

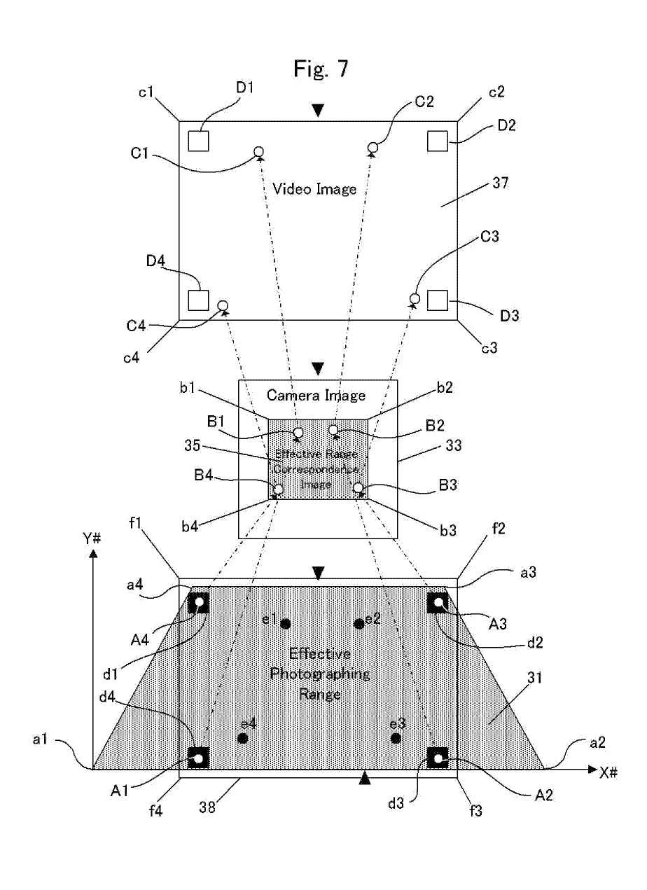

By the way, if the video image 37 generated by the processor 23 is projected onto the screen 21 as it is, the upper side c1-c2 of the video image 37 is projected as the lower side f1-f2 of the projection video image 38. Thus, when the player 15 looks at the projection video image 38 under the position relation as shown in FIGS. 1 and 2, the upper and the lower sides are reverse. Therefore, as shown in FIG. 7, it is required to turn the video image 37 upside down (vertically-mirror inversion) and project onto the screen 21. Incidentally, in FIG. 7, in the video image 37, the effective range correspondence image 35, the effective photographing range 31, and the projection video image 38, the upper side c1-c2, the upper side b1-b2, the lower base a1-a2, and the upper side f1-f2, which are indicated by the black triangles, correspond to one another.

It is required to project the images e1, to e4 in the projection video image 38 onto the retroreflective sheet A1 to A4 respectively in order to utilize the projection video image 38 as a user interface. Because, the processor 23 recognizes the position of the retroreflective sheet 17 via the cursor 67 following the retroreflective sheet 17 and thereby recognizes where the retroreflective sheet 17 is present on the projection video image. However, in FIG. 7, the images e1, e2, e3 and e4 correspond to A4, A3, A2 and A1 respectively.

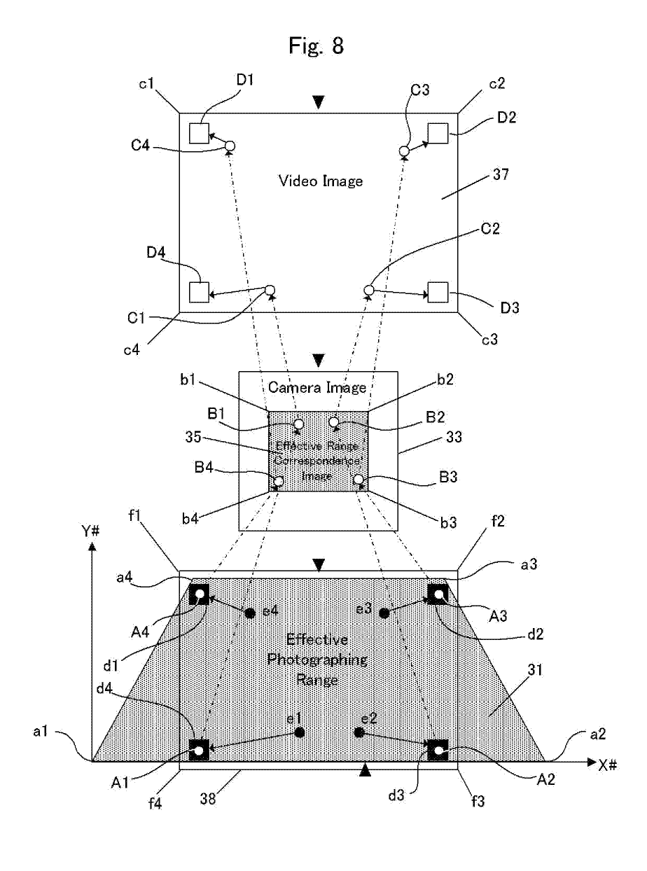

Therefore, as shown in FIG. 8, the images C1 to C4 are arranged at positions in the video image 37, which correspond to positions obtained by turning the positions of the images B1 to B4 in the effective range Correspondence image 35 upside down (vertically-mirror inversion). And, the video image 37 containing the images C1 to C4 is turned upside down (vertically-mirror inversion) and is projected onto the screen 21, and thereby the projection video image 38 is obtained. Further, the correction is performed so that the images e1, e2, e3 and e4 respectively overlap with the retroreflective sheets A1, A2, A3 and A4, i.e., the images d4, d3, d2 and d1. Then, the images e1 to e4 in the projection video image 38 are projected onto the retroreflective sheets A1 to A4 respectively, and thereby the projection video image 38 can be utilized as the user interface.

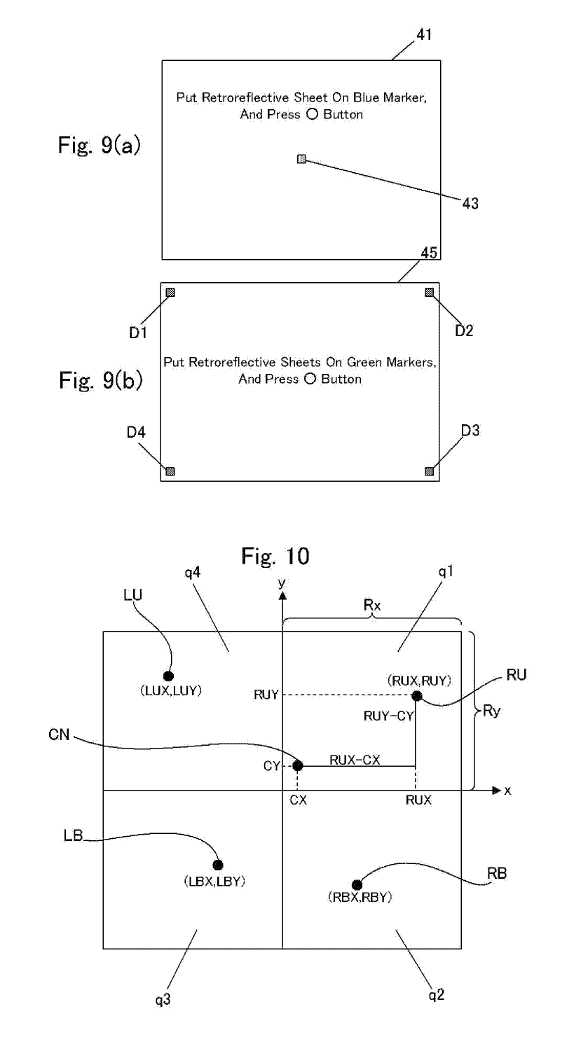

FIGS. 9(a) and 9(b) are views for showing an example of a calibration screen (a screen for calculating parameters (a reference magnification and a reference gradient) which are used in performing the keystone correction). Referring to FIG. 9(a), the processor 23 generates a video image (a first step video mage) 41 for a first step of the calibration. The video image 41 contains a marker 43 which is located at a central position thereof. Since the video image 41 is projected onto the screen 21 in a manner shown in FIG. 8, an image, which corresponds to the video image 41 as it is, is projected as the projection video image. Accordingly, the player 15 puts a retroreflective sheet CN (not shown in the figure) on a marker m (not shown in the figure) in the projection video image, which corresponds to the marker 43, in accordance with guidance in the projection video image, which corresponds to guidance in the video image 41. Then, the processor 23 computes xy coordinates (CX, CY) on the video image 41 of the retroreflective sheet CN put on the marker m in the projection video image.

Next, as shown in FIG. 9(b), the processor 23 generates a video image (a second step video image) 45 for a second step of the calibration. The video image 45 contains markers D1 to D4 which are located at four corners thereof. The markers D1 to D4 correspond to the image D1 to D4 of FIG. 8. Since the video image 45 is projected onto the screen 21 in a manner shown in FIG. 8, an image, which corresponds to the video image 45 as it is, is projected as the projection video image. Accordingly, the player 15 puts retroreflective sheets LU, RU, RB and LB (not shown in the figure) on markers d1 to d4 in the projection video image, which correspond to the markers D1 to D4, in accordance with guidance in the projection video image, which corresponds to guidance in the video image 45. The markers d1 to d4 correspond to the images d1 to d4 of FIG. 8. Then, the processor 23 computes xy coordinates (LUX,LUY), (RUX,RUY), (RBX,RBY) and (LBX,LBY) on the video image 45 of the retroreflective sheets LU, RU, RB and LB put on the markers d1 to d4 in the projection video image.

FIG. 10 is an explanatory view for showing a method of deriving the reference magnification which is used in performing the keystone correction. Referring to FIG. 10, a central position of the video image is assigned to origin, a horizontal axis corresponds to an x axis, and a vertical axis corresponds to a y axis. A positive direction of the x axis corresponds to a rightward direction as viewed from the drawing, and a positive direction of the y axis corresponds to an upward direction as viewed from the drawing.

It is assumed that the xy coordinates on the video image of the retroreflective sheet CN put on the marker m as described in FIG. 9(a) are (CX, CY). It is assumed that the xy coordinates on the video image of the retroreflective sheets LU, RU, RB and LB put on the markers d1 to d4 as described in FIG. 9(b) are (LUX, LUY), (RUX, RUY), (RBX, RBY) and (LBX, LBY) respectively. The retroreflective sheets LU, RU, RB and LB are positioned in a fourth quadrant q4, a first quadrant q1, a second quadrant q2 and a third quadrant q3 respectively.

The reference magnifications of the xy coordinates in the first quadrant q1 will be obtained focusing on the retroreflective sheet RU positioned in the first quadrant q1. The reference magnification PRUX of the x coordinate and the reference magnification PRUY of the y coordinate can be obtained by the following formulae.

PRUX=Rx/(RUX−CX) (1)

PRUY=Ry/(RUY−CY) (2)

In this case, a constant Rx is an x coordinate of the marker D2 in the video image, and a constant Ry is a y coordinate of the marker D2 in the video image.

In a similar manner, the reference magnifications of the xy coordinates in the second quadrant q2 will be obtained focusing on the retroreflective sheet RB positioned in the second quadrant q2. The reference magnification PRBX of the x coordinate and the reference magnification PRBY of the y coordinate can be obtained by the following formulae.

PRBX=Rx/(RBX−CX) (3)

PRBY=Ry/(CY−RBY) (4)

In a Similar manner, the reference magnifications of the xy coordinates in the third quadrant q3 will be obtained focusing on the retroreflective sheet LB positioned in the third quadrant q3. The reference magnification PLBX of the x coordinate and the reference magnification PLBY of the y coordinate can be obtained by the following formulae.

PLBX=Rx/(CX−LBX) (5)

PLBY=Ry/(CY−LBY) (6)

In a similar manner, the reference magnifications of the xy coordinates in the fourth quadrant q4 will be obtained focusing on the retroreflective sheet LU positioned in the fourth quadrant q4. The reference magnification FLUX, of the x coordinate and the reference magnification PLUM of the y coordinate can be obtained by the following formulae.

PLUX=Rx/(CX−LUX) (7)

PLUY=Ry/(LUY−CY) (8)

When the retroreflective sheet 17, which the player 15 moves, is positioned in the first quadrant q1, the keystone correction can be performed by multiplying the x coordinate in the video image by the reference magnification PRUX and multiplying the y coordinate by the reference magnification PRUY. When the retroreflective sheet 17, which the player 15 moves, is positioned in the second quadrant q2, the keystone correction can be performed by multiplying the x coordinate in the video image by the reference magnification PRBX and multiplying the y coordinate by the reference magnification PRBY. When the retroreflective sheet 17, which the player 15 moves, is positioned in the third quadrant q3, the keystone correction can be performed by multiplying the x coordinate in the video image by the reference magnification PLBX and multiplying the y coordinate by the reference magnification PLBY. When the retroreflective sheet 17, which the player 15 moves, is positioned in the fourth quadrant q4, the keystone correction can be performed by multiplying the x coordinate in the video image by the reference magnification PLUX and multiplying the y coordinate by the reference magnification PLUY.

However, like this, if the keystone correction is performed using uniformly the reference magnification depending on the quadrant where the retroreflective sheet 17 is positioned, inexpedience may occur depending on the position of the retroreflective sheet 17.

For example, in the vicinity of a part where the first quadrant q1 comes in contact with the second quadrant q2, the reference magnifications of the x coordinates are supposed to be nearly equal to each other essentially irrespective of the quadrant where the retroreflective sheet 17 is positioned. However, in the case where the keystone correction is performed using uniformly the reference magnification depending on the quadrant, if there is a great difference between the reference magnification PRUX of the x coordinate in the first quadrant q1 and the reference magnification PRBX of the x coordinate in the second quadrant q2, a difference similar thereto occurs also in the vicinity of the part where the first quadrant q1 comes in contact with the second quadrant q2, and the discontinuity is caused.

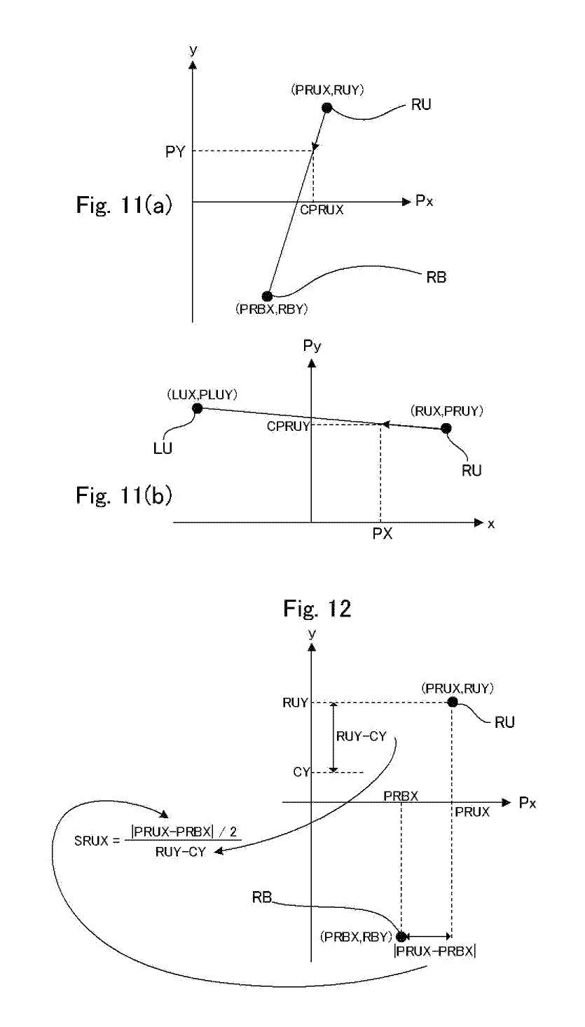

For this reason, in this case, as shown in FIG. 11(a), the reference magnification PRUX of the x coordinate in the first quadrant q1 is corrected on the basis of the gradient of the reference magnification of the x coordinate with respect to the y axis, and the y coordinate of the retroreflective sheet 17 which is positioned in the first quadrant q1. For example, when the y coordinate of the retroreflective sheet 17 which is positioned in the first quadrant q1 is PY, the reference magnification is corrected to CPRUX on the basis of the gradient of the reference magnification of the x coordinate with respect to the y axis.

Returning to FIG. 10, for example, in the vicinity of a part where the first quadrant q1 comes in contact with the fourth quadrant q4, the reference magnifications of the y coordinates are supposed to be nearly equal to each other essentially irrespective of the quadrant where the retroreflective sheet 17 is positioned. However, in the case where the keystone correction is performed using uniformly the reference magnification depending on the quadrant, if there is a great difference between the reference magnification PRUY of the y coordinate in the first quadrant q1 and the reference magnification PLUY of the y coordinate in the fourth quadrant q4, a difference similar thereto occurs also in the vicinity of the part where the first quadrant q1 comes in contact with the fourth quadrant q4, and the discontinuity is caused.

For this reason, in this case, as shown in FIG. 11(b), the reference magnification PRUY of the y coordinate in the first quadrant q1 is corrected on the basis of the gradient of the reference magnification of the y coordinate with respect to the x axis, and the x coordinate of the retroreflective sheet 17 which is positioned in the first quadrant q1. For example, when the x coordinate of the retroreflective sheet 17 which is positioned in the first quadrant q1 is PX, the reference magnification is corrected to CPRUY on the basis of the gradient of the reference magnification of the y coordinate with respect to the x axis.

Incidentally, in the similar manner, the reference magnifications of the xy coordinates in the second quadrant q2 to fourth quadrant q4 are also corrected.

In what follows, the correction of the reference magnifications of the xy coordinates in the first quadrant q1 will be described in detail.

Referring to FIG. 12, the reference gradient SRUX for correcting the reference magnification PRUX of the x coordinate in the first quadrant q1 (the formula (1)) is calculated by the following formula.

SRUX=PRUX−PRBXI/2)/(RUY−CY) (9)

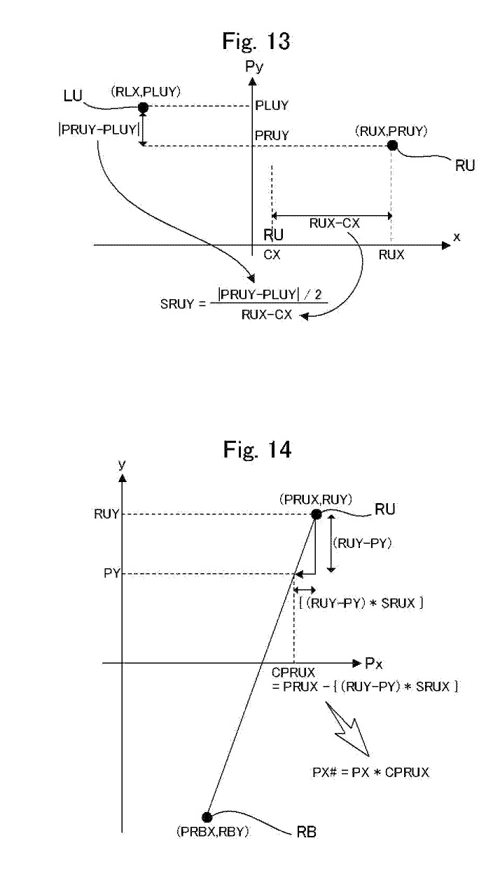

Referring to FIG. 13, the reference gradient SRUY for correcting the reference magnification PRUY of the y coordinate in the first quadrant q1 (the formula (2)) is calculated by the following formula.

SRUY=(|PRUY−PLUY|/2)/(RUX−CX) (10)

In a similar manner, the reference gradient SRBX for correcting the reference magnification PRBX of the x coordinate in the second quadrant q2 (the formula (3)) is calculated by the following formula.

SRBX=(|PRUX−PRBX|/2)/(CY−RBY) (11)

In a similar manner, the reference gradient SRBY for correcting the reference magnification PRBY of the y coordinate in the second quadrant q2 (the formula (4)) is calculated by the following formula.

SRBY=(|PRBY−PLBY|/2)/(RBX−CX) (12)

In a similar manner, the reference gradient SLBX for correcting the reference magnification PLBX of the x coordinate in the third quadrant q3 (the formula (5)) is calculated by the following formula.

SLBX=(|PLUX−PLEX|/2)/(CY−LBY) (13)

In a similar manner, the reference gradient SLBY for correcting the reference magnification PLBY of the y coordinate in the third quadrant q3 (the formula (6)) is calculated by the following formula.

SLBY=(|PRBY−PLBY|/2)/(CX−LBX) (14)

In a similar manner, the reference gradient SLUX for correcting the reference magnification PLUX of the x coordinate in the fourth quadrant q4 (the formula (7)) is calculated by the following formula.

SLUX=(|PLUX−PLBX|/2)/(LUY−CY) (15)

In a similar manner, the reference gradient SLUY for correcting the reference magnification PLUY of the y coordinate in the fourth quadrant q4 (the formula (8)) is calculated by the following formula.

SLUY=(|PRUY−PLUY|/2)/(CX−LUX) (16)

FIG. 14 is an explanatory view for showing a method of correcting the reference magnification PRUX of the x coordinate in the first quadrant q1 by using the reference gradient SRUX. Referring to FIG. 14, the y coordinate of the retroreflective sheet 17 which is positioned in the first quadrant q1 is PY. In this case, a corrected value CPRUX of the reference magnification PRUX of the x coordinate is calculated by the following formula.

[Case of PRUX>PRBX (Example of FIG. 14)]

CPRUX=PRUX−{(FRUY−PY)*SRUX} (17)

[Case of PRUX≦PRBX].

CPRUX=PRUX+{(RUY−PY)*SRUX} (18)

Accordingly, a value PX# after applying the keystone correction to the x coordination PX of the retroreflective sheet 17 which is positioned in the first quadrant q1 is expressed by the following formula.

PX#=PX*CPRUX (19)

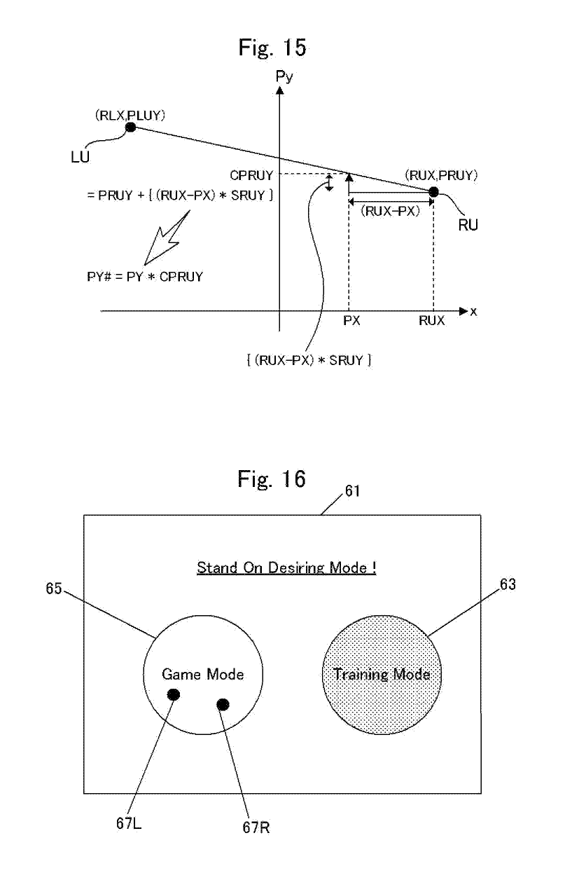

FIG. 15 is an explanatory view for showing a method of correcting the reference magnification PRUY of the y coordinate in the first quadrant q1 by using the reference gradient SRUY. Referring to FIG. 15, the x coordinate of the retroreflective sheet 17 which is positioned in the first quadrant q1 is PX. In this case, a corrected value CPRUY of the reference magnification PRUY of the y coordinate is calculated by the following formula.

[Case of PRUY>PLUY]

CPRUY=PRUY−{(RUX−PX)*SRUY} (20)

[Case of PRUY≦PLUY (Example of FIG. 15)]

CPRUY=PRUY+{(RUX−PX)*SRUY} (21)

Accordingly, a value PY# after applying the keystone correction to the y coordination PY of the retroreflective sheet 17 which is positioned in the first quadrant q1 is expressed by the following formula.

PY#=PY*CPRUY (22)

In a similar manner, the y coordinate of the retroreflective sheet 17 which is positioned in the second quadrant q2 is PY. In this case, a corrected value CPRBX of the reference magnification PRBX of the x coordinate is calculated by the following formula.

[Case of PRBX>PRUX]

CPRBX=PRBX−{(RBY−PY)*SRBX} (23)

[Case of PRBX≦PRUX]

CPRBX=PRBX+{(RBY−PY)*SRBX} (24)

Accordingly, a value PX# after applying the keystone correction to the x coordination PX of the retroreflective sheet 17 which is positioned in the second quadrant q2 is expressed by the following formula.

PX#=PX*CPRBX (25)

In a similar manner, the x coordinate of the retroreflective sheet 17 which is positioned in the second quadrant q2 is PX. In this case, a corrected value CPRBY of the reference magnification PRBY of the y coordinate is calculated by the following formula.

[Case of PRBY>PLBY]

CPRBY=PRBY−{(RBX−PX)*SRBY} (26)

[Case of PRBY≦PLBY]

CPRBY=PRBY+{(RBX−PX)*SRBY} (27)

Accordingly, a value. PY# after applying the keystone correction to the y coordination PY of the retroreflective sheet 17 which is positioned in the second quadrant q2 is expressed by the following formula.

PY#=PY*CPRBY (28)

In a similar manner, the y coordinate of the retroreflective sheet 17 which is Positioned in the third quadrant q3 is PY. In this case, a corrected value CPLBX of the reference magnification PLBX of the x coordinate is calculated by the following formula.

[Case of PLBX>PLUX]

CPLBX=PLBX−{(LBY−PY)*SLBX} (29)

[Case of PLBX≦PLUX]

CPLBX=PLBX+{(LBY−PY)*SLBX} (30)

Accordingly, a value PX# after applying the keystone correction to the x coordination PX of the retroreflective sheet 17 which is positioned in the third quadrant q3 is expressed by the following formula.

PX#=PX*CPLBX (31)

In a similar manner, the x coordinate of the retroreflective sheet 17 which is positioned in the third quadrant q3 is PX. In this case, a corrected value CPLBY of the reference magnification PLBY of the y coordinate is calculated by the following formula.

[Case of PLBY>PRBY]

CPLBY=PLBY−{(LBX−PX)*SLBY} (32)

[Case of PLBY≦PRBY]

CPLBY=PLBY+{(LBX−PX)*SLBY} (33)

Accordingly, a value PY# after applying the keystone correction to the y coordination PY of the retroreflective sheet 17 which is positioned in the third quadrant q3 is expressed by the following formula.

PY#=PY*CPLBY (34)

In a similar-Manner, the y coordinate of the retroreflective sheet 17 which is positioned in the fourth quadrant q4 is PY. In this case, a corrected value CPLUX of the reference magnification PLUX of the x coordinate is calculated by the following formula.

[Case of PLUX>PLBX]

CPLUX=PLUX−{(LUY−PY)*SLUX} (35)

[Case of PLUX≦PLBX]

CPLUX=PLUX+{(LUY−PY)*SLUX} (36)

Accordingly, a value PX# after applying the keystone correction to the x coordination PX of the retroreflective sheet 17 which is positioned in the fourth quadrant q4 is expressed by the following formula.

PX#=PX*CPLUX (37)

In a similar manner, the x coordinate of the retroreflective sheet 17 which is positioned in the fourth quadrant q4 is PX. In this case, a corrected value CPLUY of the reference magnification PLUY of the y coordinate is calculated by the following formula.

[Case of PLUY>PRUY]

CPLUY=PLUY−{(LUX−PX)*SLUY} (38)

[Case of PLUY≦PRUY]

CPLUY=PLUY+{(LUX−PX)*SLUY} (39)

Accordingly, a value PY# after applying the keystone correction to the y coordination PY of the retroreflective sheet 17 which is positioned in the fourth quadrant q4 is expressed by the following formula.

PY#=PY*CPLUY (40)

FIG. 16 is a view for showing an example of a mode selection screen 61 projected onto the screen 21 of FIG. 1. Referring to FIG. 16, the mode selection screen 61 contains icons 65 and 63 for selecting a mode, and cursors 67L and 67R.

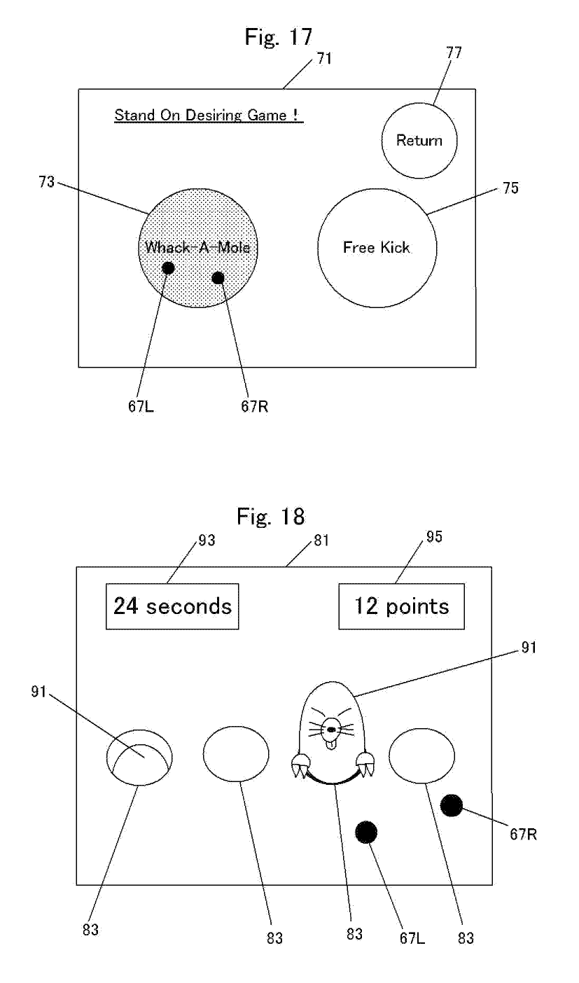

The cursor 67L follows the retroreflective sheet 17L and the cursor 67R follows the retroreflective sheet 17R. This point is, also true regarding FIGS. 17 to 22 as described below.

When both of the cursors 67L and 67R which the player 15 operates by the retroreflective sheets 17L and 17R overlap with any one of the icons 65 and 63, a countdown display is started from 3 seconds. When 3 seconds elapse, an input becomes effective, and thereby the entry to the mode corresponding to the icon 63 or 65 with which both of the cursors 67L and 67R overlap is executed. That is, when both of the cursors 67L and 67R overlap with the single icon during 3 seconds or more, the input to the icon becomes effective. In this way, the overlap continuing during the certain time is required in order to prevent the erroneous input. That is, the input is not accepted immediately when the cursor overlaps with the icon, the input is accepted only after the overlap continues during the certain time, and thereby it is possible to prevent the erroneous input. Incidentally, the icon 63 is for entering a training mode, and the icon 65 is for entering a game mode.

By the way, the positions of the cursors 67L and 67R coincide with or nearly coincide with the positions of the retroreflective sheets 17L and 17R respectively. Accordingly, the player 15 can move the cursor to a desired position in the projection video image by moving the foot on which the corresponding retroreflective sheet is worn to the desired position on the projection video image. This point is also true regarding FIGS. 17 to 22 as described below.

FIG. 17 is a view for showing an example of a game selection screen 71 projected onto the screen 21 of FIG. 1. Referring to FIG. 17, the game selection screen 71 contains icons 73 and 75 for selecting a game, and the cursors 67L and 67R. When both of the cursors 67L and 67R which the player 15 operates by the retroreflective sheets 17L and 17R overlap with any one of the icons 73 and 75, a countdown display is started from 3 seconds. When 3 seconds elapse, an input becomes effective, and thereby the game corresponding to the icon 73 or 75 with which both of the cursors 67L and 67R overlap is started. That is, when both of the cursors 67L and 67R overlap with the single icon during 3 seconds or more (the prevention of the erroneous input), the input to the icon becomes effective. Incidentally, the icon 73 is for starting a whack-a-mole game, and the icon 75 is for starting a free-kick game.

Also, when both of the cursors 67L and 67R overlap with an icon 77, a countdown display is started from 3 seconds. When 3 seconds elapse, an input becomes effective (the prevention of the erroneous input), and thereby it is returned to the previous screen (the mode selection screen 61).

FIG. 18 is a view for showing an example of the whack-a-mole screen 81 projected onto the screen 21 of FIG. 1. Referring to FIG. 18, the whack-a-mole screen 81 contains four hole images 83, an elapsed time displaying section 93, a score displaying section 95, and the cursors 67L and 67R.

A mole image 91 appears from one of the four hole images 83 in a random manner. The player 15 attempts to lap the cursor 67L or 67R on the mole image 91 at the timing when the mole image 91 appears by operating the retroreflective sheet 17L or 17R. If the cursor 67L or 67R is timely lapped on the mole image 91, a score of the score displaying section 95 increases by 1 point. The elapsed time displaying section 93 displays the result of the countdown from 30 seconds, and the game is finished when the result thereof becomes 0 second.

The player 15 timely steps on the mole image 91 by foot on which the retroreflective sheet 17L or 17R is worn, and thereby can lap the corresponding cursor 67L or 67R on the mole image 91. Because, on the screen 21, the position of the retroreflective sheet coincides with or nearly coincides with the position of the cursor.

Incidentally, although the hole images 83 are displayed in a line horizontally, the plurality of horizontally-lines may be displayed. As the number of the lines is increased more, the difficulty level is higher. Also, the number of the hole images 83 can be set optionally. Further, the plurality of the mole images 91 may simultaneously appear from the plurality of the hole images 83. As the number of the mole images 91 which simultaneously appear is increased more, the difficulty level is higher. Also, the difficulty level can be adjusted by adjusting the appearance interval of the mole image 91.

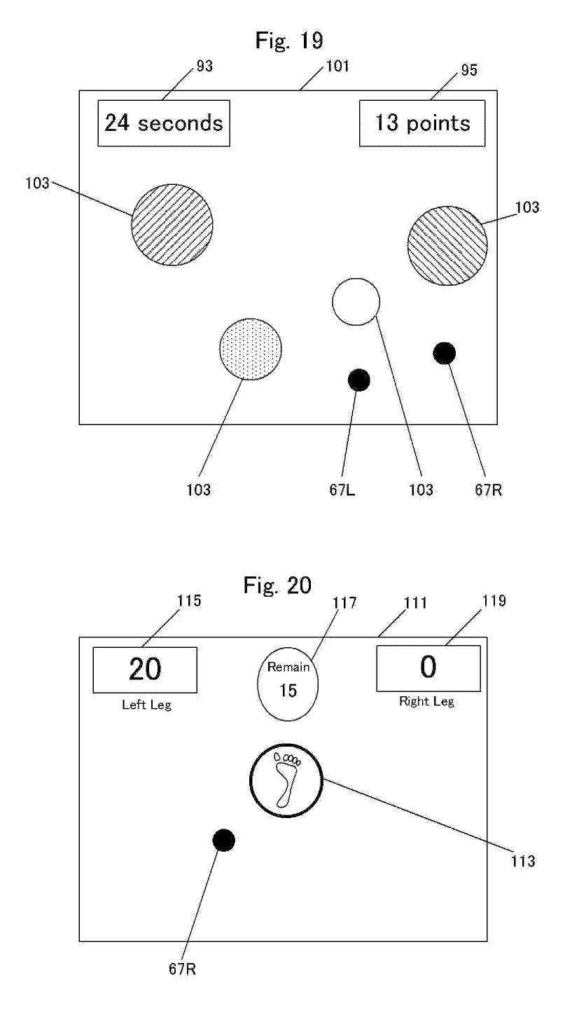

FIG. 19 is a view for showing an example of a free-kick screen 101 projected onto the screen 21 of FIG. 1. Referring to FIG. 19, the free-kick screen 101 contains ball images 103, an elapsed time displaying section 93, a score displaying section 95, and the cursors 67L and 67R.

The ball image 103 vertically descends from the upper end of the screen toward the lower end thereof with constant velocity. The position on the upper end of the screen from which the ball image 103 appears is determined in a random manner. Since the ball images 103 appear one after another and descend, the player moves the cursor 67L or 67R to the descending ball image 103 by operating the retroreflective sheet 17L or 17R. In this case, if the cursor comes in contact with the ball image 103 with the velocity which is a certain value or more, the ball image 103 is hit back in the opposite direction, and the score of the score displaying section 95 is increased by 1 point. On the other hand, even, when the cursor comes in contact with the ball image 103, if the velocity of the cursor is not the certain value or more the ball image 103 disappears at the lower end of the screen without being hit back. The elapsed time displaying section 93 displays the result of the countdown from 30 seconds, and the game is finished when the result thereof becomes 0 second.

The player 15 timely performs such a motion as to kick the ball image 103 by foot on which the retroreflective sheet 17L or 17R is worn, and thereby can bring the corresponding cursor 67L or 67R into contact with the ball image 103. Because, on the screen 21, the position of the retroreflective sheet coincides with or nearly coincides with the position of the cursor.

FIG. 20 is a view for showing an example of a one-leg-jump screen 111 projected onto the screen 21 of FIG. 1. The one-leg-jump screen 111 instructs the player 15 to consecutively jump on the one-leg. The play is performed by the left leg during 15 seconds of the first half, and the play is performed by the right leg during 15 seconds of the second half.

Referring to FIG. 20, the one-leg-jump screen 111 contains a left leg score displaying section 115, a right leg score displaying section 119, an elapsed time displaying section 117, a guide image 113, and the cursors 67L and 67R.

When the player 15 jumps on the left leg and thereby the cursor 67L overlaps with the guide image 113, the score of the left leg score displaying section 115 is increased by 1 point while the guide image 113 moves to the other position. The player 15 jumps on the left leg so as to lap the cursor 67L on the guide image 113 as moved. Then, the score of the left leg score displaying section 115 is increased by 1 point while the guide image 113 moves to the still other position. Such play is repeated during 15 seconds. Incidentally, in the present embodiment, the guide image 113 moves the three vertexes of the triangle in the counterclockwise direction.

When the play of the left leg is performed for 15 seconds, the guide for instructing to perform the play of the right leg is displayed. When the player 15 jumps on the right leg and thereby the cursor 67R overlaps with the guide image 113, the score of the right leg score displaying section 119 is increased by 1 point while the guide image 113 moves to the other position. The player 15 jumps on the right leg so as to lap the cursor 67R on the guide image 113 as moved. Then, the score of the right leg score displaying section 119 is increased by 1 point while the guide image 113 moves to the still other position. Such play is repeated during 15 seconds. Incidentally, in the present embodiment, the guide image 113 moves the three vertexes of the triangle in the clockwise direction.

The elapsed time displaying section 117 displays the result of the countdown from 30 seconds, and the game is finished when the result thereof becomes 0 second. Incidentally, when the play of the left leg is instructed, the guide image 113 representing a left sole is displayed. When the play of the right leg is instructed, the guide image 113 representing a right sole is displayed.

The player 15 steps on the guide image 113 by foot on which the retroreflective sheet 17L or 17R is worn, and thereby can move the corresponding cursor 67L or 67R toward the guide image 113. Because, on the screen 21, the position of the retroreflective sheet coincides with or nearly coincides with the position of the cursor.

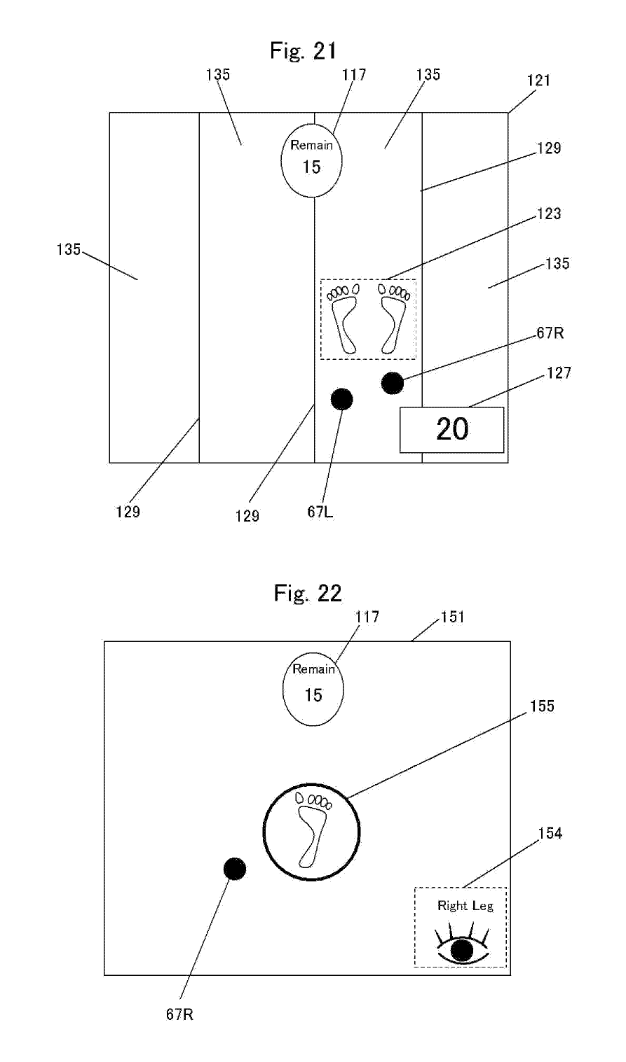

FIG. 21 is a view for showing an example of a both-leg-jump screen 121 projected onto the screen 21 of FIG. 1. Referring to FIG. 21, the both-leg-jump screen 121 contains an elapsed time displaying section 117, a score displaying section 127, three vertically-extended lines 129, a guide image 123, and the cursors 67L and 67R. The screen is divided into four areas 135 by the three lines 129.

The both-leg-jump screen 121 instructs the player 15 to jump on the both legs. Specifically, the player 15 attempts to leap over the line 129 by jumping on the both legs in accordance with the guide image 123.

When the player 15 jumps on the both legs and thereby both of the cursors 67L and 67R move to the area 135 where the guide image 123 is positioned, the score of the score displaying section 127 is increased by 1 point while the guide image 123 moves to the other area 135. The player 15 jumps so that both of the cursors 67L and 67R move to the area 135 where the guide image 123 as moved is positioned. Then, the score of the score displaying section 127 is increased by 1 point while the guide image 113 moves to the still other area 135. Such play is repeated during 15 seconds.

The elapsed time displaying section 117 displays the result of the countdown from 30 seconds, and the game is finished when the result thereof becomes 0 second.

The player 15 moves to the area 135 where the guide image 123 is positioned by jumping on feet on which the retroreflective sheets 17L and 17R are worn, and thereby can move the corresponding cursors 67L and 67R to the area 135. Because, on the screen 21, the position of the retroreflective sheet coincides with or nearly coincides with the position of the cursor.

FIG. 22 is a view for showing an example of a one-leg-stand screen 151 projected onto the screen 21 of FIG. 1. The one-leg-stand screen 151 instructs the player 15 to stand on the left leg with the opened eyes during 30 seconds, stand on the right leg with the opened eyes during 30 seconds, stand on the left leg with the closed eyes during 30 seconds, and stand on the right leg with the closed eyes during 30 seconds.

Referring to FIG. 22, the one-leg-stand screen 151 contains an elapsed time displaying section 117, a sole image 155, an indicating section 154, and the cursors 67L and 67R.

The indicating section 154 indicates any one of the standing on the left leg with the opened eyes, the standing on the right leg with the opened eyes, the standing on the left leg with the closed eyes, and the standing on the right leg with the closed eyes by text and an image representing an eye. In the present embodiment, the indications are performed in the order of the standing on the left leg with the opened eyes, the standing on the right leg with the opened eyes, the standing on the left leg with the closed eyes, and the standing on the right leg with the closed eyes. Thirty seconds are assigned to each. Also, the standing on the left leg is indicated if the sole image 155 represents the left sole while the standing on the right leg is indicated if the sole image 155 represents the right sole.

In the example of FIG. 22, the indicating section 154 indicates the standing on the right leg with the opened eyes. In this case, the player 15 attempts to stand on the right leg so that the cursor 67R overlaps with the sole image 155. An OK counter is counted up while the cursor 67R overlaps with the sole image 155, and an NG counter is counted up while the cursor 67R does not overlap with the sole image 155. When the time of the elapsed time displaying section 117 becomes from 30 seconds to 0 second, the standing on the right leg with the opened eyes is finished, and then the indicating section 154 displays the next indication.

The player 15 steps on the sole image 155 by the foot on which the retroreflective sheet 17L or 17R is worn so as to stand on the one leg, and thereby can retain the corresponding cursor 67L or 67R in the sole image 155. Because, on the screen 21, the position of the retroreflective sheet coincides with or nearly coincides with the position of the cursor.

Incidentally, although it is required that the cursor overlaps with the predetermined image (63, 65, 73, 75, 77, 91, 103, 113 and 155) in FIGS. 16 to 20 and FIG. 22, even when these have contact with each other, the same treatment as when overlapping may be given.

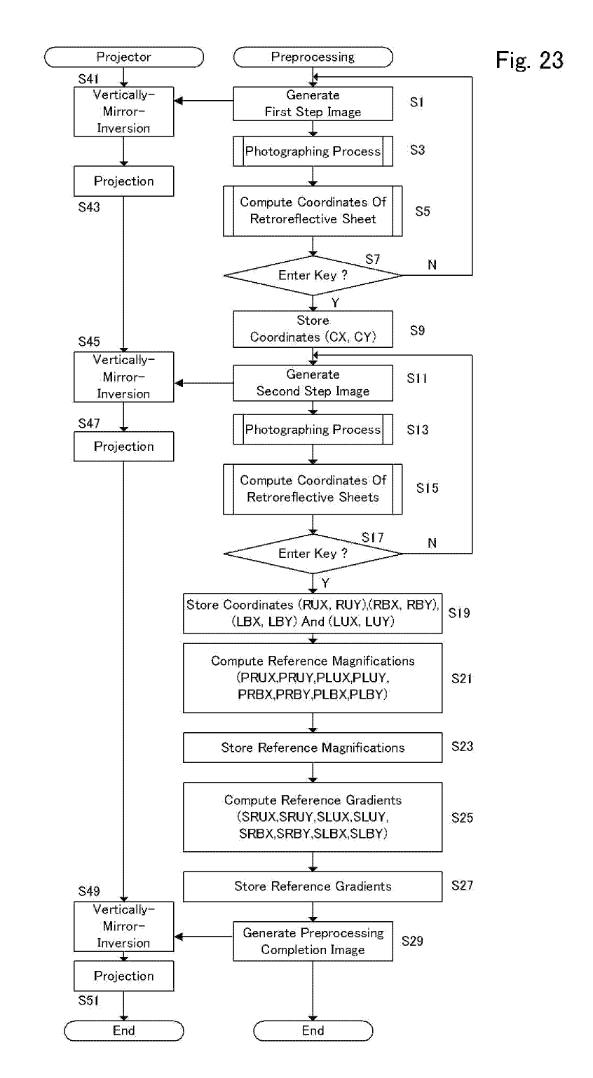

FIG. 23 is a flow chart showing preprocessing (a process for obtaining parameters (the reference magnifications and the reference gradients) for the keystone correction) of the processor 23 of FIG. 3. Referring to FIG. 23, in step S1, the processor 23 generates the first step video image 41 in order to give to the projector 11 (refer to FIG. 9(a)). Then, the projector 11 applies vertically-mirror-inversion to the first step video image 41 in step S41, and projects it onto the screen 21 in step S43.

In step S3, the processor 23 performs a process for photographing the retroreflective sheet CN put on the marker m (refer to the description of FIG. 9(a)). In step S5, the processor 23 calculates the xy coordinates (CX, CY) of the retroreflective sheet CN on the first step video image 41. In step S7, the processor 23 determines whether or not the player 15 presses the enter key (the switch section 22), the process proceeds to step S9 if it is pressed, otherwise the process returns to step S1. In step S9, the processor 23 stores the calculated coordinates (CX, CY) in the external memory 25.

In step S11, the processor 23 generates the second step video image 45 (refer to FIG. 9(b)). Then, the projector 11 applies vertically-mirror-inversion to the second step video image 45 in step S45, and projects it onto the screen 21 in step S47.

In step S13, the processor 23 performs a process for photographing the retroreflective sheets LU, RU, RB and LB put on the markers d1 to d4 (refer to the description of FIG. 9(b)). In step S15, the processor 23 calculates the xy coordinates (LUX, LUY), (RUX, RUY), (RBX, RBY) and (LBX,LBY) of the retroreflective sheets LU, RU, RB and LB on the second step video image 45. In step S17, the processor 23 determines whether or not the player 15 presses the enter key (the switch section 22), the process proceeds to step S19 if it is pressed, otherwise the process returns to step S11. In step S19, the processor 23 stores the calculated coordinates (LUX, LUY), (RUX, RUY), (RBX, RBY) and (LBX, LBY) in the external memory 25.

In step S21, the processor 23 calculates the reference magnifications PRUX, PRUY, PLUX, PLUY, PRBX, PRBY, PLBX and PLBY by using the coordinates stored in steps S9 and S19, and the formulae (1) to (8). In step S23, the processor 23 stores the calculated reference magnifications in the external memory 25.

In step S25, the processor 23 calculates the reference gradients SRUX, SRUY, SLUX, SLUY, SRBX, SRBY, SLBX and SLBY on the basis of the coordinates stored in steps S9 and S19, the reference magnifications stored in step S23, and the formulae (9) to (16). In step S27, the processor 23 stores the calculated reference gradients in the external memory 25.

In step S29, the processor 23 generates a preprocessing completion video image for informing the player 15 the completion of the preprocessing, and gives it to the projector 11. Then, the projector 11 applies the vertically-mirror-inversion to the preprocessing completion video image in step S49, and projects it onto the screen 21 in step S51.

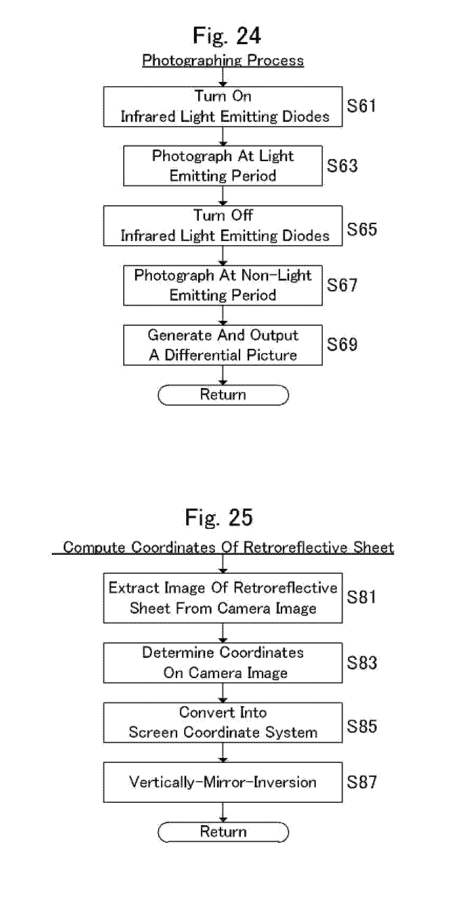

FIG. 24 is a flow chart showing the photographing process of step S3 of FIG. 23. Referring to FIG. 24, in step S61, the processor 23 makes the image sensor 27 turn on the infrared light emitting diodes 7. In step S63, the processor 23 makes the image sensor 17 perform the photographing process in the tine when the infrared light is emitted. In step S65, the processor 23 makes the image sensor 17 turn off the infrared light emitting diodes 7. In step S67, the processor 23 makes the image sensor 27 perform the photographing process in the time when the infrared light is not emitted. In step S69, the processor 23 makes the image sensor 27 generate and output the differential picture (camera image) between the picture in the time when the infrared light is emitted and the picture in the time when the infrared light is not emitted. As described above, the image sensor 27 performs the photographing process in the time when the infrared light is emitted and the photographing process in the time when the infrared light is not emitted, i.e., the stroboscope imaging, under the control by the processor 23. Also, the infrared light emitting diodes 7 operate as a stroboscope by the above control.

Incidentally, the photographing process of step S13 of FIG. 23 is the same as the photographing process of FIG. 24, and therefore the description thereof is omitted.

FIG. 25 is a flow chart showing the coordinate calculating process of step S5 of FIG. 23. Referring to FIG. 25, in step S81, the processor 23 extracts the image of the retroreflective sheet CN from the camera image (the differential picture) as received from the image sensor 27. In step S83, the processor 23 determines XY coordinates of the retroreflective sheet CN on the camera image on the basis of the image of the retroreflective sheet CN. In step S85, the processor 23 converts the XY coordinates of the retroreflective sheet CN on the camera image into xy coordinates into a screen coordinate system. The screen coordinate system is a coordinate system in which a video image generated by the processor 23 is arranged. In step S87, the processor 23 obtains the xy coordinates (CX, CY) by applying the vertically-mirror-inversion to the xy coordinates obtained in step S85. The reason to perform this process is as explained in FIG. 8. In passing, the vertically-mirror-inversion may be applied to the XY coordinates obtained in step S83, and the obtained coordinates may be given to step S85. In this case, the output of step S85 is the xy coordinates (CX, CY), and there is no step S87.

Incidentally, the coordinate calculating process of step S15 of FIG. 23 is similar to the coordinate calculating process of FIG. 25. However, in the coordinate calculating process of step S15, in the explanation of FIG. 25, the retroreflective sheet CN is replaced by the retroreflective sheets LU, RU, RB and LB, and the xy coordinates (CX, CY) are replaced by the xy coordinates (LUX, LUY), (RUX, RUY), (RBX, RBY) and (LBX,LBY).

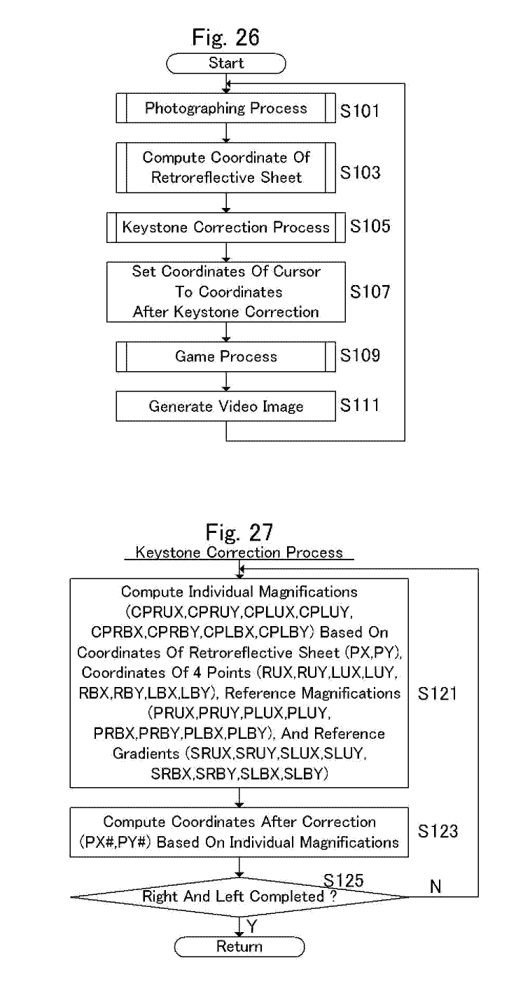

FIG. 26 is a flow chart showing the overall process of the processor 23 of FIG. 3, which is performed after finishing the preprocessing of FIG. 23. Referring to FIG. 26, in step S101, the processor 23 performs a photographing process. This process is the same as the process of FIG. 24, and therefore the description thereof is omitted. In step S103, the processor 23 computes the xy coordinates (PX_{L}, PY_{L}) and (PX_{R}, PY_{R}) of the retroreflective sheets 17L and 17R on the video image. This process is similar to the process of FIG. 25. However, in the coordinate calculating process of step S103, in the explanation of FIG. 25, the retroreflective sheet CN is replaced by the retroreflective sheets 17L and 17R, and the xy coordinates (CX, CY) are replaced by the xy coordinates (PX_{L}, PY_{L}) and (PX_{R}, PY_{R}).

In step S105, the processor 23 applies the keystone correction to the coordinates (PX_{L}, PY_{L}) and (PX_{R}, PY_{R}) obtained in step S103 on the basis of formulae (17) to (40), and obtains coordinates (PX#_{L}, PY#_{L}) and (PX#_{R}, PY#_{R}) after the keystone correction.

In step S107, the processor 23 sets coordinates of the cursors 67L and 67R to the coordinates (PX#_{L}, PY#_{L}) and (PX#_{R}, PY#_{R}) after the keystone correction respectively. Accordingly, the coordinates of the cursors 67L and 67R are synonymous with the coordinates of the retroreflective sheets 17L and 17R on the video image after applying the keystone correction.

In step S109, the processor 23 performs a game process (e.g., the control of the various screens of FIGS. 16 to 22). In step S111, the processor 23 generates the video image depending on the result of the process in step S109 (e.g., the various screens of FIGS. 16 to 22), sends it to the projector 11, and then returns to step S101. The projector 11 applies the vertically-mirror-inversion to the video image received from the processor 23, and projects it onto the screen 21.

Incidentally, the PX_{L} and PX_{R} may be referred to as the “PX” in the case where they need not be distinguished, the PY_{L} and PY_{R} may be referred to as the “PY” in the case where they need not be distinguished, the PX#_{L} and PX#_{R} may be referred to as the “PX#” in the case where they need not be distinguished, and the PY#_{L} and PY#_{R} may be referred to as the “PY#” in the case where they need not be distinguished.

FIG. 27 is a flow chart showing the keystone correction process of step S105 of FIG. 26. Referring to FIG. 27, in step S121, the processor 23 computes the corrected values (hereinafter referred to as the “individual magnifications”) CPRUX, CPRUY, CPLUX, CPLUY, CPRBX, CPRBY, CPLBX and CPLBY of the reference magnifications on the basis of the xy coordinates (PX, PY) of the retroreflective sheet 17 stored in step S103 of FIG. 26, the xy coordinates (LUX, LUY), (RUX, RUY), (RBX, RBY) and (LBX, LBY) stored in step S19 of FIG. 23, the reference magnifications PRUX, PRUY, PLUX, PLUM, PRBX and PRBY stored in step S23 of FIG. 23, the reference gradients SRUX, SRUY, SLUX, SLUY, SRBX, SRBY, SLBX and SLBY stored in step S27 of FIG. 23, and the formulae (17), (18), (20), (21), (23), (24), (26), (27), (29), (30), (32), (33), (35), (36), (38) and (39).

In step S123, the processor 23 computes the xy coordinates (PX#, PY#) of the retroreflective sheet 17 after applying the keystone correction on the basis of the xy coordinates (PX, PY) of the retroreflective sheet 17 stored in step S103 of FIG. 26, the individual magnifications computed in step S121, and the formulae (19), (22), (25), (28), (31), (34), (37) and (40).

In step S125, the processor 23 determines whether or not the processes of steps S121 and S123 are completed with respect to the left and right retroreflective sheets 17L and 17R, the processor 23 returns to step S121 if they are not completed, conversely the processor 23 returns if they are completed.

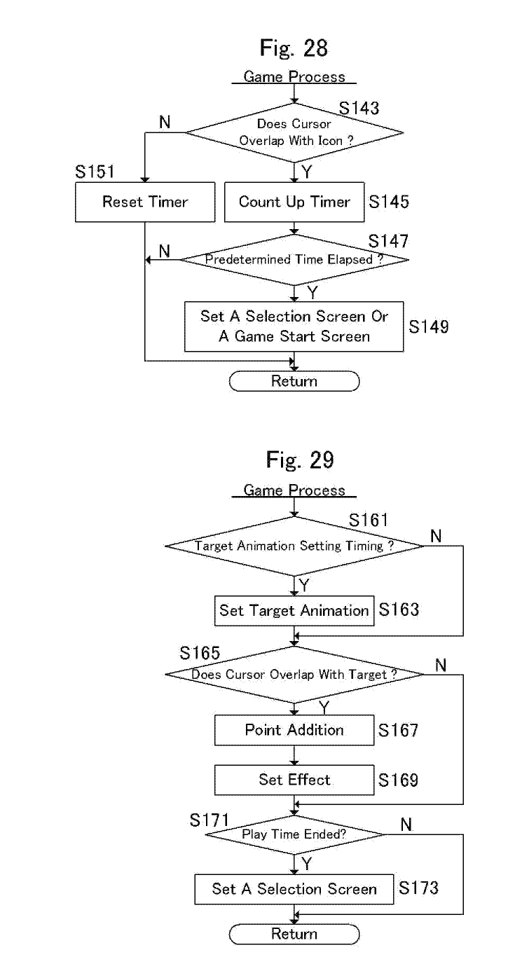

FIG. 28 is a flow chart showing a first example of the game process of step S109 of FIG. 26. For example, the control of the screens of FIGS. 16 and 17 is performed by the process of FIG. 28.

Referring to FIG. 28, in step S143, the processor 23 determines whether or not both of the cursors 67L and 67R overlap with the icon (in the examples of FIGS. 16 and 17, the icon 63, 65, 73, 75 or 77), the process proceeds to step S145 if they overlap, otherwise the process proceeds to step S151. In step S145, the processor 23 counts up a timer, and then proceeds to step S147. In step S147, the processor 23 refers to the timer and determines whether or not a predetermined time (in the examples of FIGS. 16 and 17, 3 seconds) is elapsed after the cursors 67L and 67R overlap with the icon, the process proceeds to step S149 if it is elapsed, conversely the process returns if it is not elapsed. In step S149, the processor 23 sets the other selection screen or the game start screen depending on the icon with which the cursors 67L and 67R overlap, and returns. By the way, in step S151 after “NO” is determined in step S143, the processor 23 resets the timer to 0, and then returns.

FIG. 28 is a flow chart showing a second example of the game process of step S109 of FIG. 26. For example, the control of the screen of FIG. 18 is performed by the process of FIG. 29.

Referring to FIG. 29, in step S161, the processor 23 determines whether or not a thing to set animation of a target (the example of FIG. 18, the mole image 91) comes, the process proceeds to step S163 if the timing comes, otherwise the process proceeds to step S165. In step S163, the processor 23 sets the animation of the target (the example of FIG. 18, sets such animation as the mole image 91 appears from any one of four hole images 83).

In step S165, the processor 23 determines whether or not one of the cursors 67L and 67R overlaps with the target, the process proceeds to step S167 if it overlaps, otherwise the process proceeds to step S171. In step S167, the processor 23 performs a point-addition process for the score displaying section 95. In step S169, the processor 23 sets an effect expressing success (image and sound).

In step S171, the processor 23 determines whether or not the play time in the elapsed time displaying section 93 is 0, the process proceeds to step S173 if 0, otherwise the process returns. In step S173 after “YES” is determined in step S171, the processor 23 ends the game, sets the selection screen, and then returns.

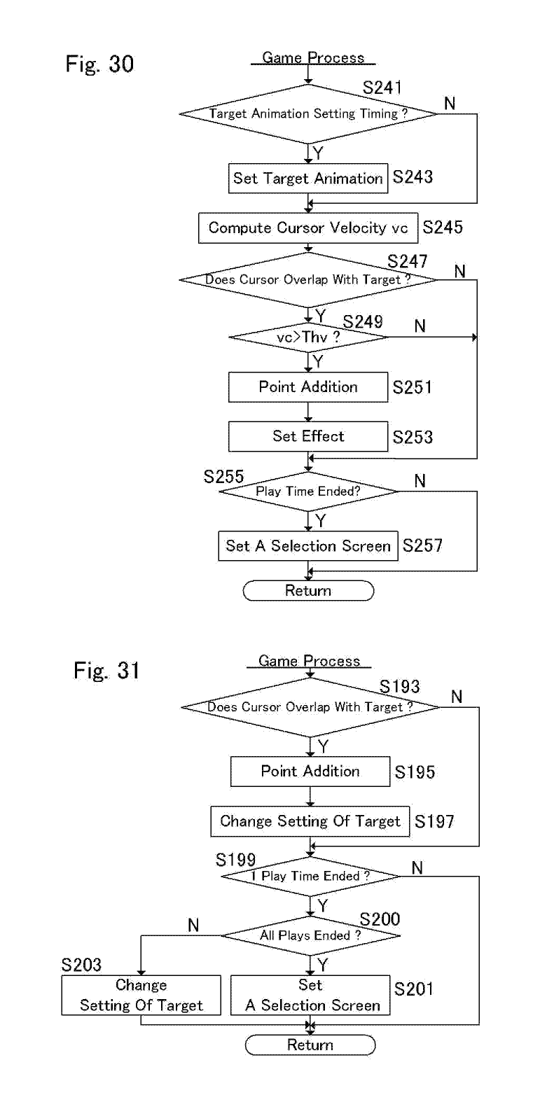

FIG. 30 is a flow chart showing a third example of the game process of step S109 of FIG. 26. For example, the control of the screen of FIG. 19 is performed by the process of FIG. 30.

Referring to FIG. 30, in step S241, the processor 23 determines whether or not a timing to set animation of a target (the example of FIG. 19, the ball image 103) comes, the process proceeds to step S243 if the timing comes, otherwise the process proceeds to step S245. In step S243, the processor 23 sets the animation of the target (in the example of FIG. 19, sets such animation as the ball image 103 appears from any position of the upper edge of the screen and descends). In step S245, the processor 23 calculates y components vcL and vcR of the velocities of the cursors 67L and 67R. Incidentally, in the figure, the y components vcL and vcR are collectively referred to as the “vc”.

In step S247, the processor 23 determines whether or not one of the cursors 67L and 67R overlaps with (or comes in contact with) the target, the process proceeds to step S249 if it overlaps, otherwise the process proceeds to step S255. In step S249, the processor 23 determines whether or not the y component of the velocity of the cursor as come in contact with the target exceeds a threshold value Thv, the process proceeds to step S251 if it exceeds, otherwise the process proceeds to step S255.

In step S251, the processor 23 performs a point-addition process for the score displaying section 95. In step S253, the processor 23 sets an effect expressing success (image and sound).

In step S255, the processor 23 determines whether or not the play time in the elapsed time displaying section 93 is 0, the process proceeds to step S257 if 0, otherwise the process returns. In step S257 after “YES” is determined in step S255, the processor 23 ends the game, sets the selection screen, and then returns.

FIG. 31 is a flow chart showing a fourth example of the game process of step S109 of FIG. 26. For example, the control of the screens of FIGS. 20 and 21 is performed by the process of FIG. 31.

Referring to FIG. 31, in step S193, the processor 23 determines whether or not the cursor(s) (one corresponding to the indicated foot among the cursors 67L and 67R in the example of FIG. 20, or both of the cursors 67L and 67R in the example of FIG. 21) overlaps with the target (the guide image 113 in the example of FIG. 20, or the area 135 where the guide 123 is positioned in the example of FIG. 21), the process proceeds to step S195 if it overlaps, otherwise the process proceeds to step S199.

In step S195, the processor 23 performs a point-addition process for the score displaying section (one corresponding to the indicated foot between the score displaying sections 115 and 119 in the example of FIG. 20 or the score displaying section 127 in the example of FIG. 21). In step S197, the processor 23 changes the setting (position) of the target (the guide image 113 in the example of FIG. 20, or the guide image 123 in the example of FIG. 21).

In step S199, the processor 23 determines whether or not a 1 play time in the elapsed time displaying section 117 (15 seconds in the example of FIG. 20, or 30 seconds in the example of FIG. 21) ends, the process proceeds to step S200 if it ends, otherwise the process returns. In step S200, the processor 23 determines whether or not all the plays (the left leg and right leg in the example of FIG. 20, or only 1 play in the example of FIG. 21) end, the process proceeds to step S201 if all end, otherwise the process proceeds to step S203.

In step S203 after “NO” is determined in step S200, the processor 23 changes the setting of the target (the guide image 113 in the example of FIG. 20), and then returns. On the other hand, in step S201 after “YES” is determined in step S200, the processor 23 ends the game, sets the selection screen, and then returns.

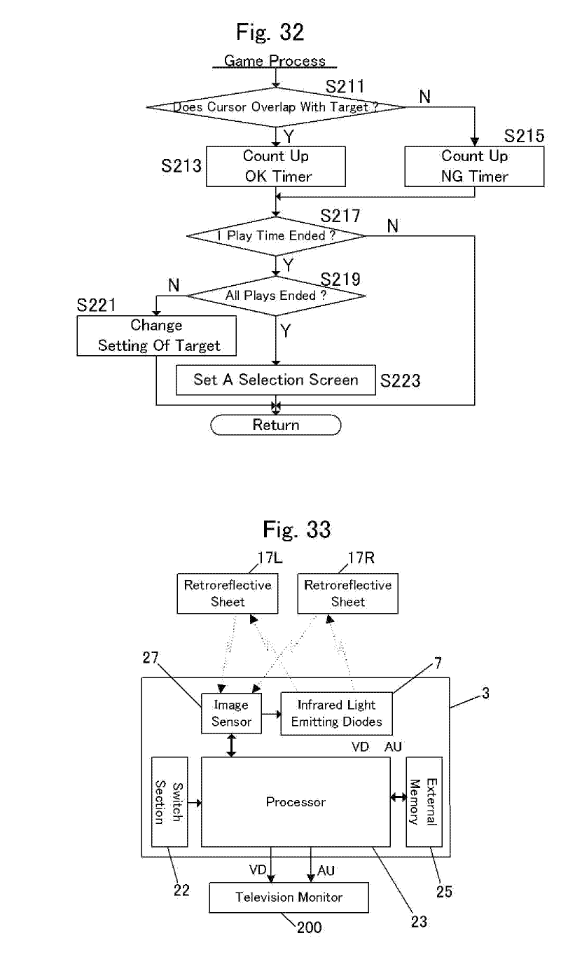

FIG. 32 is a flow chart showing a fifth example of the game process of step S109 of FIG. 26. For example, the control of the screen of FIG. 22 is performed by the process of FIG. 32.

Referring to FIG. 32, in step S211; processor 23 determines whether or not any one of the cursors 67L and 67R overlaps with the target (the sole image 155 in the example of FIG. 22), the process proceeds to step S213 if it overlaps, otherwise the process proceeds to step S215. In step S213, the processor 23 counts up an OK timer for measuring a time for which any one of the cursors 67L and 67R overlaps with the target. On the other hand, in step S215, an NG timer for measuring a time for which the cursors 67L and 67R do not overlap with the target is counted up.

In step S217, the processor 23 determines whether or not a 1 play time (30 seconds in the example of FIG. 22) in the elapsed tine displaying section 117 ends, the process proceeds to step S219 if it ends, otherwise the process returns. In step S219, the processor 23 determines whether or not all the plays (in the example of FIG. 22, the standing on the left leg with the opened eyes, the standing on the right leg with the opened eyes, the standing on the left leg with the closed eyes, and the standing on the right leg with the closed eyes) end, the process proceeds to step S223 if all end, otherwise the process proceeds to step S221.

In step S221 after “NO” is determined in step S219, the processor 23 changes the setting of the target (the sole image 155 and the indicating section 154 in the example of FIG. 22), and then returns. On the other hand, in step S223 after “YES” determined in step S219, the processor 23 ends the game, sets the selection screen, and then returns.

By the way, as described above, in accordance with the present embodiment, the position of the cursor 67 is controlled so that the position of the retroreflective sheet (subject) 17 in the real space coincides with or nearly coincides with the position of the cursor 67 in the projected video image, on the screen 21 in the real space. Hence, the player 15 can perform the input to the processor 23 by moving the retroreflective sheet 17 on the video image projected onto the screen 21 and indicating directly the desired location in the video image by the retroreflective sheet 17. Because, on the screen 21 in the real space, the position of the retroreflective sheet 17 in the real space nearly coincides with the position of the cursor 67 in the projected video image, and therefore the processor 23 can recognize, through the cursor 67, the position in the video mage on which the retroreflective sheet 17 is placed.

Also, in accordance with the present embodiment, in the case where the retroreflective sheet 17 moves from the back to the front when seen from the image sensor 27, the position of the cursor 67 is determined so that the projected cursor 67 moves from the back to the front when seen from the image sensor 27. In addition, in the case where the retroreflective sheet 17 moves from the front to the back when seen from the image sensor 27, the position of the cursor 67 is determined so that the projected cursor 67 moves from the front to the back when seen from the image sensor 27. In addition, in the case where the retroreflective sheet 17 moves from the right to the left when seen from the image sensor 27, the position of the cursor 67 is determined so that the projected cursor 67 moves from the right to the left when seen from the image sensor 27. In addition, in the case where the retroreflective sheet 17 moves from the left to the right when seen from the mage sensor 27, the position of the cursor 67 is determined so that the projected cursor 67 moves from the left to the right when seen from the image sensor 27.

Hence, even the case (hereinafter referred to as the “downward case”) where the photographing is performed from such a location as to look down at the retroreflective sheet 17 in front of the player 15, the moving direction of the retroreflective sheet 17 operated by the player 15 coincides with the moving direction of the cursor 67 on the screen 21 sensuously, and therefore it is possible to perform the input to the processor 23 easily while suppressing the stress in inputting as much as possible.

In passing, in the case (hereinafter referred to as the “upward case”) where the photographing is performed from such a location as to look up at the retroreflective sheet 17 in front of the player 15, usually, if the retroreflective sheet moves from the back to the front when seen from the image sensor, the position of the cursor is determined so that the cursor moves upward when the player looks at the video image displayed on the screen which is vertically installed, and if the retroreflective sheet moves from the front to the back when seen from the image sensor, the position of the cursor is determined so that the cursor moves downward when the player looks at the video image displayed on the screen which is vertically installed.

However, in the downward case, if the cursor is controlled by the same algorithm as the upward case, when the retroreflective sheet moves from the back to the front when seen from the image sensor, the result is that the position of the cursor is determined so that the cursor moves downward when the player looks at the video image displayed on the screen which is vertically installed, and when the retroreflective sheet moves from the front to the back when seen from the image sensor, the result is that the position of the cursor is determined so that the cursor moves upward when the player looks at the video image displayed on the screen. In this case, the moving direction of the retroreflective sheet operated by the player does not coincide with the moving direction of the cursor on the screen sensuously. Hence, since the input is fraught with stress, it is not possible to perform the input smoothly.

The reason for causing such fact is that a vertical component Vv of an optical axis vector V of the image sensor faces the vertical, downward direction in the downward case, and therefore the up and down directions of the image sensor do not coincide with the up and down directions of the player (see FIG. 4).

Also, because, in many cases, the optical axis vector V of the image sensor does not have the vertical component (i.e., the photographing surface is parallel to the vertical plane), or the vertical component Vv of the optical axis vector V faces vertically upward, the image sensor is installed so that the up and down directions of the image sensor coincide with the up and down directions of the player, and there is the habituation of such usage.

In this case, the direction which faces the starting point from the ending point of the vertical component Vv of the optical axis vector V of the image sensor corresponds to the downward direction of the image sensor, and the direction which faces the ending point from the starting point thereof corresponds to the upward direction of the image sensor (see FIG. 4). Also, the direction which faces the head from the foot of the player corresponds to the upward direction of the player, and the direction which faces the foot from the head thereof corresponds to the downward direction of the player.

Further, in accordance with the present embodiment, the keystone correction is applied to the position of the retroreflective sheet 17 obtained from the camera image. Hence, even the case where the image sensor 27, which is installed so that the optical axis is oblique with respect to the plane to be photographed, photographs the retroreflective sheet 17 on the plane to be photographed, moreover the movement of the retroreflective sheet 17 is analyzed on the basis of the camera image, and still moreover the cursor 67 which moves in conjunction therewith is generated, the movement of the retroreflective sheet 17 operated by the player coincides with or nearly coincides with the movement of the cursor. Because, the keystone correction is applied to the position of the retroreflective sheet 17 which defines the position of the cursor 67. As the result, the player can perform the input while suppressing the sense of the incongruity as much as possible.

Still further, in accordance with the present embodiment, the infrared emitting diodes 7 are intermittently driven, the differential picture (the camera image) between the time when the infrared light is emitted and the time when the infrared light is not emitted is generated, and the movement of the retroreflective sheet 17 is analyzed on the basis thereof. In this way, it is possible to eliminate, as much as possible, noise of light other than the light reflected from the retroreflective sheet 17 by obtaining the differential picture, so that only the retroreflective sheet 17 can be detected with a high degree of accuracy.

Still further, in accordance with the present embodiment, since various objects (63, 65, 73, 75, 77, 91, 103, 113, 123 and 155) are displayed on the projection video image, these can be used as the icon for issuing the command, the various items in the video game, and so on.

Also, the processor 23 determines whether or not the cursor 67 comes in contact with or overlaps with the moving predetermined image (e.g., the ball image 103 of FIG. 19) under the satisfaction of the predetermined requirement (e.g., step S249 of FIG. 30). Thus, it is not sufficient that the player 15 merely operates the retroreflective sheet 17 so that the cursor 67 comes in contact with the predetermined image, and the player 15 has to operate the retroreflective sheet 17 so that the predetermined requirement is also satisfied. As the result, it is possible to improve the game element and the difficulty level. Incidentally, although the predetermined requirement is that the cursor 67 exceeds the certain velocity in the game of FIG. 30, the requirement may be set depending on the specification of the game.

Further, in accordance with the present embodiment, the camera unit 5 photographs the retroreflective sheet 17 from such a location as to look down at the retroreflective sheet 17. Hence, the player 15 can operate the cursor 67 by moving the retroreflective sheet 17 on the floor surface or on the screen 21 placed on the floor surface. As described above, the player 15 wears the retroreflective sheet 17 on the foot and moves it. Accordingly, it is possible to apply to the game using the foot, the exercise using the foot, and so on.

Still further, in accordance with the present embodiment, it is possible to simply obtain the parameters for the keystone correction only by making the player 15 put the retroreflective sheets CN, LU, RU, RB and LB on the markers m and d1 to d4. Especially, the retroreflective sheets CN, LU, RU, RB and LB are put on the markers m and d1 to d4 which are arranged at the plurality of the locations in the projection video image, and thereby the parameters for the keystone correction are obtained, and therefore it is possible to more improve the accuracy of the keystone correction.

### Second Embodiment

In the second embodiment, the other example of the keystone correction will be described. Also, in the first embodiment, the video image generated by the processor 23 is projected onto the screen 21. In contrast, the second embodiment cites the example that the video image generated by the processor 23 is displayed on a display device having a vertical screen such as a television monitor.

FIG. 33 is a view showing the electric configuration of an entertainment system in accordance with the second embodiment of the present invention. Referring to FIG. 33, the entertainment system is provided with an information processing apparatus 3, retroreflective sheets (retroreflective members) 17L and 17R which reflect received light retroreflectively, and a television monitor 200. Also, the information processing apparatus 3 includes the same camera unit 5 as that of the first embodiment.

In essence, in the electric configuration of the second embodiment, the television monitor 200 is employed in place of the projector 11 and the screen 21 of FIG. 3. Accordingly, in the second embodiment, the video image signal VD and the audio signal AU by the processor 23 are sent to the television monitor 200.

Besides, the upper left corner of the camera image 33 is assigned to origin, a horizontal axis corresponds to an X axis, and a vertical axis corresponds to a Y axis. A positive direction of the X axis corresponds to a horizontally-rightward direction, and a positive direction of the Y axis corresponds to a vertically-downward direction.

By the way, like the first embodiment, the player 15 wears the retroreflective sheet 17L on an instep of a left foot by a rubber band 19, and wears the retroreflective sheet 17R on an instep of a right foot by a rubber band 19. And, the information processing apparatus 3 is installed in front of the player 15 (e.g., about 0.7 meters) so that its height is a prescribed height from a floor surface (e.g., 0.4 meters), and the camera unit 5 photographs the floor surface with a prescribed depression angle (e.g., 30 degrees). Of course, the configuration capable of adjusting the height may be employed. Also, the television monitor 200 is installed in front of the player 15, and above the information processing apparatus 3 and in the rear of the information processing apparatus 3 (when seen from the player 15), or just above the information processing apparatus 3. Accordingly, the camera unit 5 views the retroreflective sheets 17L and 17R diagonally downward ahead.

Next, the keystone correction of the X coordinate will be described.

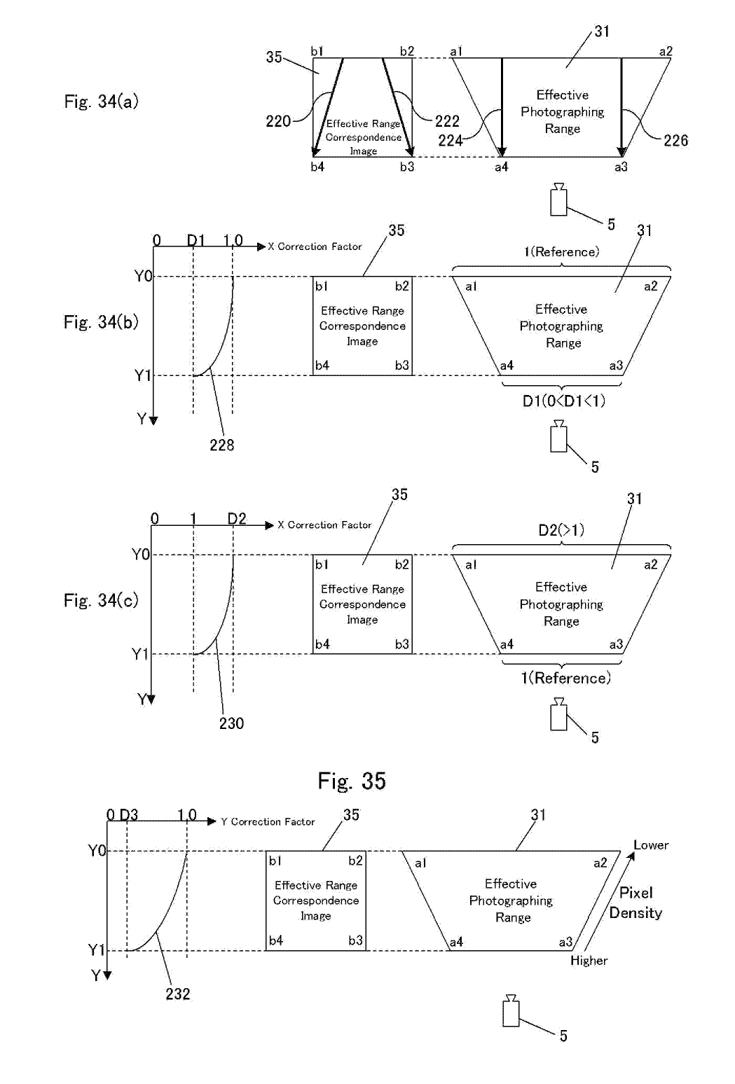

FIG. 34(a) is an explanatory view for showing necessity of the keystone correction of the X coordinate in the present embodiment. Referring to FIG. 34(a), it is assumed that the player 15 straight moves the retroreflective sheet 17 in the effective photographing range 31 like an arrow 226, i.e., along the Y# axis (see FIG. 4). However, since the camera unit 5 looks down at the retroreflective sheet 17, the trapezoidal distortion occurs. Therefore, in the effective range correspondence image 35 of the camera image 33, as shown by an arrow 222, the image of the retroreflective sheet 17 moves so as to open outward. Also in the case where the retroreflective sheet 17 is moved as shown by an arrow 224, in the effective range correspondence image 35, as shown by an arrow 220, the image of the retroreflective sheet 17 moves so as to open outward. Because, as the distance to the camera unit 5 is longer, the trapezoidal distortion is larger, as the distance to the camera unit 5 is longer, the pixel density in the effective photographing range 31 is lower, and as the distance is shorter, the pixel density in the effective photographing range 31 is higher.

Accordingly, if the movement of the cursor 67 is controlled on the basis of the effective range correspondence image 35, variance occurs between the feeling of the player 15 and the movement of the cursor 67. The keystone correction is performed in order to resolve the variance arisen from the trapezoidal distortion.

FIG. 34(b) is an explanatory view for showing a first example of the keystone correction to the X coordinate (horizontal coordinate) Xp of the retroreflective sheet 17 in the effective range correspondence image 35 of the camera image 33. Referring to FIG. 34(b), in the first example, the keystone correction is applied to the X coordinate Xp with reference to the side a1-a2 of the effective photographing range 31, i.e., on the basis of the side a1-a2 as “1”

A correction factor (an X correction factor) cx(Y) of the X coordinate Xp of the image of the retroreflective sheet 17 is expressed by a curved line 228 depending on the Y coordinate of the image of the retroreflective sheet 17. That is, the X correction factor cx(Y) is a function of Y. In the case where the Y coordinate of the image is the same as the Y coordinate Y0 of the side b1-b2 (corresponding to the side a1-a2) of the effective range correspondence image 35, the X correction factor cx(Y) reaches the maximum value “1”. In the case where the Y coordinate of the image is the same as the Y coordinate Y1 of the side b4-b3 (corresponding to the side a4-a3) of the effective range correspondence image 35, the X correction factor cx(Y) reaches the minimum value “D1 (0<D1<1)”. Incidentally, in the present embodiment, a table (an X table) which relates the Y coordinates to the X correction factors cx(Y) is preliminarily prepared in the external memory 25.

The processor 23 obtains the X coordinate Xf after the keystone correction by the following formula. In this case, the central coordinates of the effective range correspondence image 35 are expressed, by (Xc, Yc).

Xf=Xc−(Xc−Xp)*cx(Y) (41)

FIG. 34(c) is an explanatory view for showing a second example of the keystone correction to the X coordinate (horizontal coordinate) Xp of the retroreflective sheet 17 in the effective range correspondence image 35 of the camera image 33. Referring to FIG. 34(c), in the second example, the keystone correction is applied to the X coordinate Xp with reference to the side a4-a3 of the effective photographing range 31, i.e., on the basis of the side a4-a3 as “1”.

A correction factor (an X correction factor) cx(Y) of the X coordinate Xp of the image of the retroreflective sheet 17 is expressed by a curved line 230 depending on the Y coordinate of the image of the retroreflective sheet 17. That is, the X correction factor cx(Y) is a function of Y. In the case where the Y coordinate of the image is the same as the Y coordinate Y0 of the side b1-b2 (corresponding to the side a1-a2) of the effective range correspondence image 35, the X correction factor cx(Y) reaches the maximum value “D2(>1)”. In the case where the Y coordinate of the image is the same as the Y coordinate Y1 of the side b4-b3 (corresponding to the side a4-a3) of the effective range correspondence image 35, the XX correction factor cx(Y) reaches the minimum value “1”. Incidentally, in the present embodiment, a table (an X table) which relates the Y coordinates to the X correction factors cx(Y) is preliminarily prepared in the external memory 25.

The processor 23 obtains the X coordinate Xf after the keystone correction by the formula (41).

Next, the keystone correction of the Y coordinate will be described.

FIG. 35 is an explanatory view for showing the keystone correction to the Y coordinate (vertical coordinate) Yp of the retroreflective sheet 17 in the effective range correspondence image 35 of the camera image 33.

First, necessity of the keystone correction of the Y coordinate will be described. Referring to FIG. 35, as the distance to the camera unit 5 is longer, the trapezoidal distortion is larger, as the distance to the camera unit 5 is longer, the pixel density in the effective photographing range 31 is lower, and as the distance is shorter, the pixel density in the effective photographing range 31 is higher. Hence, even the case where the retroreflective sheet 17 is moved in parallel to the Y# axis (see FIG. 4) by a certain length on the effective photographing range 31, as the distance between the camera unit 5 and the retroreflective sheet 17 is longer, the moving distance of the image of the retroreflective sheet 17 on the effective range correspondence image 35 is shorter, and as the distance is shorter, the moving distance is longer. Accordingly, even the case where the player 15 moves the retroreflective sheet 17 frontward with a certain velocity on the effective photographing range 31, as the retroreflective sheet 17 comes closer to the camera unit 5, the velocity of the cursor 67 is faster, and thereby variance occurs between the feeling of the player 15 and the movement of the cursor 67. Therefore, the keystone correction of the Y coordinate is performed in order to resolve the variance.

Next, a method of the keystone correction of the Y coordinate will be described. Referring to FIG. 35, A correction factor (a Y correction factor) cy(Y) of the Y coordinate Yp of the image of the retroreflective sheet 17 is expressed by a curved line 232 depending on the Y coordinate of the image of the retroreflective sheet 17. That is, the Y correction factor cy(Y) is a function of Y. In the case where the Y coordinate of the image is the same as the Y coordinate Y0 of the side b1-b2 (corresponding to the side a1-a2) of the effective range correspondence image 35, the Y correction factor cy(Y) reaches the maximum value “1”. In the case where the Y coordinate of the image is the same as the Y coordinate Y1 of the side b4-b3 (corresponding to the side a4-a3) of the effective range correspondence image 35, the Y correction factor cx(Y) reaches the minimum value “D3 (>0)”. Incidentally, in the present embodiment, a table (a Y table) which relates the Y coordinates to the Y correction factors cy(Y) is preliminarily prepared in the external memory 25.

The processor 23 obtains the Y coordinate Yf after the keystone correction by the following formula.

Yf=Yp*cy(Y) (42)

Incidentally, in this example, the keystone correction is applied to the Y coordinate Yp with reference to the side a1-a2 of the effective photographing range 31, i.e., on the basis of the side a1-a2 as “1” However, like FIG. 34(c), the keystone correction may be applied to the Y coordinate Yp with reference to the side a4-a3 of the effective photographing range 31, i.e., on the basis of the side a4-a3 as “1” In this case, for example, the Y correction factor cy(Y) is expressed by a curved line similar to the curved line 232, reaches the maximum value D4 (>1) at Y=Y0, and reaches the minimum value 1 at Y=Y1.

By the way, next, the process flow will be described using the flowcharts. In the present embodiment, the preprocessing of the first embodiment (see FIG. 23) is not performed. However, the flow of the overall process of the processor 23 according to the second embodiment is the same as that of FIG. 26. In what follows, the different points will be described mainly.

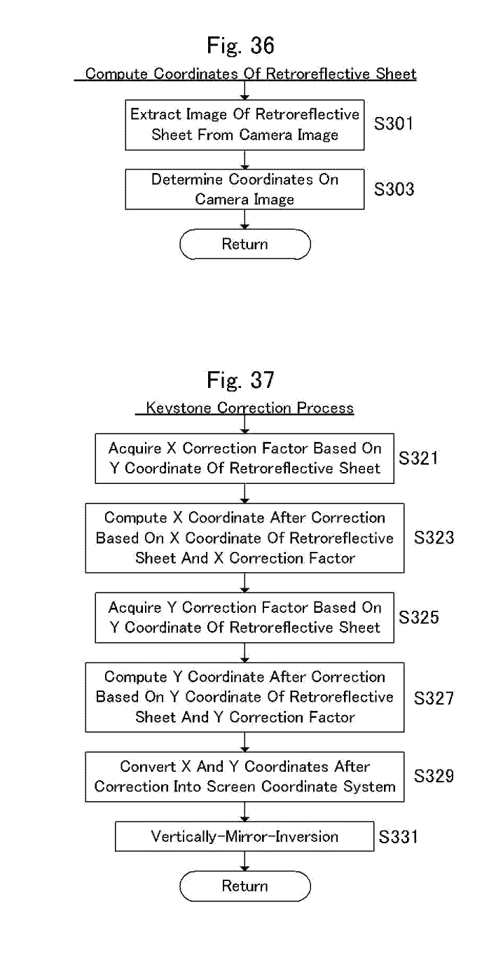

FIG. 36 is a flowchart showing a coordinate, calculating process of step S103 of FIG. 26 in accordance with the second embodiment. Referring to FIG. 36, in step S301, the processor 23 extracts the image of the retroreflective sheet 17 from the camera image (the differential picture) as received from the image sensor 27. In step S803, the processor 23 determines XY coordinates of the retroreflective sheet 17 on the camera image on the basis of the image of the retroreflective sheet 17.

FIG. 37 is a flow chart showing a keystone correction process of step S105 of FIG. 26 in accordance with the second-embodiment. Referring to FIG. 37, in step, S321, the processor 23 uses the Y coordinate of the image the retroreflective sheet as an index, to acquire the X correction factor CX corresponding thereto from the X table. In step S323, the processor 23 calculates the X coordinate Xf after correction on the basis of the formula (41).

In step S325, the processor 23 uses the Y coordinate of the image of the retroreflective sheet 17 as an index to acquire the Y correction factor cy corresponding thereto from the Y table. In step S327, the processor 23 calculates the Y coordinate Yf after correction on the basis of the formula (42).

In step S329, the processor 23 converts the X coordinate Xf after correction and the Y coordinate Yf after correction into the screen coordinate system, and thereby obtains the xy coordinates. Then, in step S331, the processor 23 applies vertically-mirror-inversion to the xy coordinates of the screen coordinate system.

As the result, in the case where the retroreflective sheet 17 moves from the back to the front when seen from the image sensor 27, the position of the cursor 67 is determined so that the cursor 67 moves from the lower position to the upper position in the screen. In addition, in the case where the retroreflective sheet 17 moves from the front to the back when seen from the image sensor 27, the position of the cursor 67 is determined so that the cursor 67 moves from the upper position to the lower position in the screen.

Hence, even the case (hereinafter referred to as the “downward case”) where the photographing is performed from such a location as to look down at the retroreflective sheet 17 in front of the player 15, the moving direction of the retroreflective sheet 17 operated by the player 15 coincides with the moving direction of the cursor 67 on the screen sensuously, and therefore it is possible to perform the input to the processor 23 easily while suppressing the stress in inputting as much as possible.

In passing, in the case (hereinafter referred to as the “upward case”) where the photographing is performed from such a location as to look up at the retroreflective sheet 17 in front of the player 15, usually, if the retroreflective sheet moves from the back to the front when seen from the image sensor, the position of the cursor is determined so that the cursor moves upward when the player looks at the video image displayed on the television monitor, and if the retroreflective sheet moves from the front to the back when seen from the image sensor, the position of the cursor is determined so that the cursor moves downward when the player looks at the video image displayed on the television monitor.

However, in the downward case, if the cursor is controlled by the same algorithm as the upward case, if the retroreflective sheet moves from the back to the front when seen from the image sensor, the result is that the position of the cursor is determined so that the cursor moves downward when the player looks at the video image displayed on the television monitor, and if the retroreflective sheet moves from the front to the back when seen from the image sensor, the result is that the position of the cursor is determined so that the cursor moves upward when the player looks at the video image displayed on the television monitor. In this case, the moving direction of the retroreflective sheet operated by the player does not coincide with the moving direction of the cursor on the television monitor sensuously. Hence, since the input is fraught with stress, it is not possible to perform the input smoothly.

The reason for causing such fact is that a vertical component Vv of an optical axis vector V of the image sensor faces the vertical downward direction in the downward case, and therefore the up and down directions of the image sensor do not coincide with the up and down directions of the player (see FIG. 4).

Also, because, in, many cases, the optical axis vector V of the image sensor does not have the vertical component (i.e., the photographing surface is parallel to the vertical plane), or the vertical component Vv of the optical axis vector V faces vertically upward, the image sensor is installed so that the up and down directions of the image sensor coincide with the up and down directions of the player, and there is the habituation of such usage.

In this case, the direction which faces the starting point from the ending point of the vertical component Vv of the optical axis vector V of the image sensor corresponds to the downward direction of the image sensor, and the direction which faces the ending point from the starting point thereof corresponds to the upward direction of the image sensor (see FIG. 4). Also, the direction which faces the head from the foot of the player corresponds to the upward direction of the player, and the direction which faces the foot from the head thereof corresponds to the downward direction of the player.

Incidentally, since the above problem does not occur with respect to the right and left directions, the particular process is not required. Therefore, if the retroreflective sheet moves from the right to the left when seen from the image sensor, the position of the cursor is determined so that the cursor moves from the right side to the left side in the screen, and if the retroreflective sheet moves from the left to the right when seen from the image sensor, the position of the cursor is determined so that the cursor moves from the left side to the right side on the screen.

By the way, referring to FIG. 26, in step S111, the processor 23 generates the video image depending on the result of the process in step S109 (FIGS. 16 to 22), and sends it to the television monitor 200. In response thereto, the television monitor 200 displays the corresponding video image.

By the way, as described above, in accordance with the present embodiment, the keystone correction is applied to the position of the retroreflective sheet 17 obtained from the camera image. Hence, even the case where the image sensor 27, which is installed so that the optical axis is oblique with respect to the plane to be photographed, photographs the retroreflective sheet 17 on the plane to be photographed, moreover the movement of the retroreflective sheet 17 is analyzed on the basis of the camera image, and still moreover the cursor 67 which moves in conjunction therewith is generated, the movement of the retroreflective sheet 17 operated by the player coincides with or nearly coincides with the movement of the cursor 67. Because, the keystone correction is applied to the position of the retroreflective sheet 17 which defines the position of the cursor 67. As the result, the player can perform the input while suppressing the sense of the incongruity as much as possible.

Also, in the present embodiment, the keystone correction is applied depending on the distance between the retroreflective sheet 17 and the camera unit 17. As the distance between the retroreflective sheet 17 and the camera unit 5 is longer, the trapezoidal distortion of the image of the retroreflective sheet 17 reflected in the camera image is larger. Accordingly, it is possible to perform the appropriate keystone correction depending on the distance.

Specifically, the X coordinate (horizontal coordinate) of the cursor 67 is corrected so that the distance between the retroreflective sheet 17 and the camera unit 5 is positively correlated with the moving distance of the cursor 67 in the X axis direction (horizontal direction). That is, as the distance between the retroreflective sheet 17 and the camera unit 5 is shorter, the moving distance of the cursor 67 in the X axis direction is shorter. As the distance is longer, the moving distance of the cursor 67 in the X axis direction is longer. In this way, the trapezoidal distortion in the X axis direction is corrected.

Also, the Y coordinate (vertical coordinate) of the cursor 67 is corrected so that the distance between the retroreflective sheet 17 and the camera unit 5 is positively correlated with the moving distance of the cursor 67 in the Y axis direction (vertical direction). That is, as the distance between the retroreflective sheet 17 and the camera unit 5 is shorter, the moving distance of the cursor 67 in the Y axis direction is shorter. As the distance is longer, the moving distance of the cursor 67 in the Y axis direction is longer. In this way, the trapezoidal distortion in the Y axis direction is corrected.

Still further, in accordance with the present embodiment, the infrared emitting diodes 7 are intermittently driven, the differential picture (the camera-image) between the time when the infrared light is emitted and the time when the infrared light is not emitted is generated, and the movement of the retroreflective sheet 17 is analyzed on the basis thereof. In this way, it is possible to eliminate, as much as possible, noise of light other than the light reflected from the retroreflective sheet 17 by obtaining the differential picture, so that only the retroreflective sheet 17 can be detected with a high degree of accuracy.

Still further, in accordance with the present embodiment, since various objects (63, 65, 73, 75, 77, 91, 103, 113, 123 and 155) are displayed on the video image, these can be used as the icon for issuing the command, the various items in the video game, and so on.

Also, the processor 23 determines whether or not the cursor 67 comes in contact with or overlaps with the moving predetermined image (e.g., the ball image 103 of FIG. 19) under the satisfaction of the predetermined requirement (e.g., step S249 of FIG. 30). Thus, it is not sufficient that the player 15 merely operates the retroreflective sheet 17 so that the cursor 67 comes in contact with the predetermined image, and the player 15 has to operate the retroreflective sheet 17 so that the predetermined requirement is also satisfied. As the result, it is possible to improve the game element and the difficulty level. Incidentally, although the predetermined requirement is that the cursor 67 exceeds the certain velocity in the game of FIG. 30, the requirement may be set depending on the specification of the game.

Further, in accordance with the present embodiment, the camera unit 5 photographs the retroreflective sheet 17 from such a location as to look down at the retroreflective sheet 17. Hence, the player 15 can operate the cursor 67 by moving the retroreflective sheet 17 on the floor surface. As described above, the player 15 wears the retroreflective sheet 17 on the foot and moves it. Accordingly, it is possible to apply to the game using the foot, the exercise using the foot, and so on.

Meanwhile, the present invention is not limited to the above embodiment, and a variety of variations may be effected without departing from the spirit and scope thereof, as described in the following modification examples.

(1) A light-emitting device such as an infrared light emitting diode may be worn instead of wearing the retroreflective sheet 17. In this case, the infrared light emitting diodes 7 are not required. Also, an imaging device such as CCD and an image sensor may image the subject (e.g., the instep of the foot of the player) without using the retroreflective sheet 17, the image analysis may be performed, and thereby the motion may be detected.

(2) Although the above stroboscope imaging (the blinking of the infrared light emitting diodes 7) and the differential processing are cited as the preferable example, these are not elements essential for the present invention. That is, the infrared light emitting diodes 7 do not have to blink, or there may be no need of the infrared light emitting diodes 7. Light to be emitted is not limited to the infrared light. Also, the retroreflective sheet 17 is not an essential element if it is possible to detect a certain part (e.g., the instep of the foot) of a body by analyzing the photographed picture. The imaging element is not limited to the image sensor, and therefore the other imaging element such as CCD may be employed.

(3) In the first embodiment, the calibration of the first step (see FIG. 9(a)) may be omitted. The calibration of the first step is performed in order to further more improve the accuracy of the correction. Also, the four markers are used in the calibration of the second step. However, the markers exceeding the four markers may be employed. Also, three or less markers may be employed. In this case, if the two markers is employed, k is preferable that the markers whose y coordinates are different from each other (e.g., D1 and D4, or D2 and D3) are employed rather than the markers whose y coordinates are the same as each other (e.g., D1 and D2, or D4 and D3). Because, the keystone correction can be simultaneously performed. If one marker is employed, or the two markers whose y coordinates are the same as each other are employed, it is required to perform the keystone correction separately. Because, in this case, it is not possible to measure the trapezoidal distortion, and therefore there is no way of correcting. In passing, in the first embodiment, the process, in which the position of the cursor 67 is corrected so that the position of the retroreflective sheet 17 in the real space coincides with or nearly coincides with the position of the cursor 67 in the projected video image, on the screen 21 in the real space, includes the keystone correction. Incidentally, considering the processing amount and the accuracy, as described above, it is preferable that the four markers are employed.

(4) In the calibration of the second step according to the first embodiment, the markers D1 to D4 are simultaneously displayed. However, the respective markers D1 to D4 may be displayed one by one by changing the time. That is, the marker D1 is first displayed, the marker D2 is displayed after acquiring data based on the marker D1, the marker D3 is displayed after acquiring data based on the marker D2, the marker D4 is displayed after acquiring data based on the marker D3, and then data based on the marker D4 is acquired.

(5) In the first embodiment, the cursor 67 is displayed so that the player 15 can visibly recognize it. In this case, the player 15 can confirm that the projected cursor 67 coincides with the retroreflective sheet 17, and recognize that the system is normal. However, the cursor 67 may be given as hypothetical one, and therefore the cursor 67 is not displayed. Because, even the case where the player 15 can not recognize the cursor 67 visibly, if the processor 23 can recognize the position of the cursor 67, the processor 23 can recognize where the retroreflective sheet 17 is placed on the projection video image. Incidentally, in this case, the cursor 67 may be made non-display, or the transparent cursor 67 may be displayed. Also, even if the cursor 67 is not displayed, the play of the player 15 is hardly affected.

(6) Also in the second embodiment, the calibration similar to that of the first embodiment may be performed. In this case, for example, the player, who wears the retroreflective sheet on one foot, stands in front of the camera unit 5. Then, the retroreflective sheet is photographed at that time, and the coordinates thereof are obtained. Next, the player 15 moves the retroreflective sheet to the forward upper-left position, the forward upper-right position, the backward lower-left position, and the backward lower-right position, the retroreflective sheet is photographed at the forward upper-left position, at the forward upper-right position, at the backward lower-left position, and at the backward lower-right position, and the coordinates are obtained. And, the parameters for the correction are calculated on the basis of these coordinates.

(7) The method of the keystone correction as cited in the above description is just an example, and therefore the other well-known keystone correction may be applied. Also, in the second embodiment, the keystone correction is applied to both of the X coordinate and the Y coordinate. However, the keystone correction may be applied to any one of the coordinates. In the experiment by the inventors, when the keystone correction is applied to only the Y coordinate, it is possible to perform the input without affecting the play in an adverse way.

(8) The keystone correction may be applied to the coordinates on the camera image, or the coordinates after converting into the screen coordinate system. Also, the processes in step S87 of FIG. 25 and in step S331 of FIG. 37 are performed after converting into the screen coordinate system. However, these processes may be performed before converting into the screen coordinate system. Further, the processes in step S87 of FIG. 25 and in step S331 of FIG. 37 are not required depending on the specification of the image sensor 27. Because, the image sensor 27 may output the camera image after the vertically-mirror inversion.

(9) In the above description, the processor 23 arranges the single marker 43 at the center in the video image 41 different from the video image 45 in which the four markers D1 to D4 are arranged. However, the markers D1 to D4 and the marker 43 may be arranged in the same video image.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1. An input system comprising:
a video image generating unit operable to generate a video image;
a controlling unit operable to control the video image;
a projecting unit operable to project the video image onto a screen placed in real space; and
a photographing unit operable to photograph a subject which is in the real space and operated by a player on the screen,
wherein the controlling unit including:
an analyzing unit operable to obtain a position of the subject on the basis of a photographed picture obtained by the photographing unit; and
a cursor controlling unit operable to make a cursor follow the subject on the basis of the position of the subject obtained by the analyzing unit, and
wherein the cursor controlling unit including:
a correcting unit operable to correct a position of the cursor so that the position of the subject in the real space coincides with the position of the cursor in the projected video image, on the screen in the real space.

2. An input system comprising:
a video image generating unit operable to generate a video image; and
a controlling unit operable to control the video image;
wherein the controlling unit including:
an analyzing unit operable to obtain a position of a subject on the basis of a photographed picture obtained by a photographing unit which photographs the subject in real space, the subject being operated by a player on a screen placed in the real space, and
a cursor controlling unit operable to make a cursor follow the subject on the basis of the position of the subject obtained by the analyzing unit, and
wherein the cursor controlling unit including:
a correcting unit operable to correct a position of the cursor so that the position of the subject in the real space coincides with the position of the cursor in the video image projected onto the screen, on the screen in the real space.

3. The input system as claimed in claim 1 or 2, further comprising:
a marker image generating unit operable to generate a video image for calculating a parameter which is used in performing the correction, and arranges a predetermined marker at a predetermined position in the video image;
a correspondence position calculating unit operable to correlate the photographed picture obtained by the photographing unit with the video image generated by the marker image generating unit, and calculate a correspondence position, which is a position in the video image corresponding to a position of an image of the subject in the photographed picture; and
a parameter calculating unit operable to calculate the parameter which the correcting unit uses in correcting on the basis of the predetermined position at which the predetermined marker is arranged, and the correspondence position when the subject is put on the predetermined marker projected onto the screen.

4. The input system as claimed in claim 3, wherein the marker image generating unit arranges a plurality of the predetermined markers at a plurality of the predetermined positions in the video image, or arranges the predetermined marker at the different predetermined positions in the video image by changing time.

5. The input system as claimed in claim 4, wherein the marker image generating unit arranges the four predetermined markers at four corners in the video image, or arranges the predetermined marker at four corners in the video image by changing time.

6. The input system as claimed in claim 5, wherein the marker image generating unit arranges the single predetermined marker at a center of the video image in which the four predetermined markers are arranged, or at a center of a different video image.

7. The input system as claimed in any one of claims 1 to 6, wherein the correction by the correcting and includes keystone correction.

8. The input system as claimed in any one of claims 1 to 7, wherein the photographing unit is installed in front of the player, and photographs from such a location as to look down at the subject, and
wherein in a case where the subject moves from a back to a front when seen from the photographing unit, the cursor controlling unit determines the position of the cursor so that the projected cursor moves from a back to a front when seen from the photographing unit, in a case where the subject moves from the front to the back when seen from the photographing unit, the cursor controlling unit determines the position of the cursor so that the projected cursor moves from the front to the back when seen from the photographing unit, in a case where the subject moves from a right to a left when seen from the photographing unit, the cursor controlling unit determines the position of the cursor so that the projected cursor moves from a right to a left when seen from the photographing unit, and in a case where the subject moves from the left to the right when seen from the photographing unit, the cursor controlling unit determines the position of the cursor so that the projected cursor moves from the left to the right when seen from the photographing unit.

9. The input system as claimed in any one of claims 1 to 8, wherein the cursor is displayed so that the player can visibly recognize it.

10. The input system as claimed in any one of claims 1 to 8, wherein the cursor is given as hypothetical one, and is not displayed.

11. An input system comprising:
a video image generating unit operable to generate a video image including a cursor;
a controlling unit operable to control the video image; and
a photographing unit configured to be installed so that an optical axis is oblique with respect to a plane to be photographed, and photograph a subject on the plane to be photographed,
wherein the controlling unit including:
an analyzing unit operable to obtain a position of the subject on the basis of a photographed picture obtained by the photographing unit;
a keystone correction unit operable to apply keystone correction to the position of the subject obtained by the analyzing unit; and
a cursor controlling unit operable to make the cursor follow the subject on the basis of a position of the subject after the keystone correction.

12. An input system comprising:
a video image generating unit operable to generate a video image including a cursor; and
a controlling unit operable to control the video image,
wherein the controlling unit including:
an analyzing unit operable to obtain a position of a subject on the basis of a photographed picture obtained by a photographing unit which is installed so that an optical axis is oblique with respect to a plane to be photographed, and photographs the subject on the plane to be photographed,
a keystone correction unit operable to apply keystone correction to the position of the subject obtained by the analyzing unit; and
a cursor controlling unit operable to make the cursor follow the subject on the basis of a position of the subject after the keystone correction.

13. The input system as claimed in claim 11 or 12, wherein the keystone correction unit applies the keystone correction depending on a distance between the subject and the photographing unit.

14. The input system as claimed in claim 13, wherein the keystone correction unit including:
a horizontally-correction unit operable to correct a horizontal coordinate of the cursor so that the distance between the subject and the photographing unit is positively correlated with a moving distance of the cursor in a horizontal direction.

15. The input system as claimed in claim 13 or 14, wherein the keystone correction unit including:
a vertically-correction unit operable to correct a vertical coordinate of the cursor so that the distance between the subject and the photographing unit is positively correlated with a moving distance of the cursor in a vertical direction.

16. The input system as claimed in any one of claims 11 to 15, wherein the photographing unit photographs from such a location as to look down at the subject.

17. The input system as claimed in any one of claims 1 to 16, further comprising:
a light emitting unit operable to intermittently irradiate the subject with light, wherein the subject including:
a retroreflective member configured to reflect received light retroreflectively,
wherein the analyzing unit obtains the position of the subject on the basis of a differential picture between a photographed picture at time when the light emitting unit irradiates the light and a photographed picture at time when the light emitting unit does not irradiate the light.

18. The input system as claimed in any one of claims 1 to 17, wherein the controlling unit including:
an arranging unit operable to arrange a predetermined image in the video image; and
a determining unit operable to determine whether or not the cursor comes in contact with or overlaps with the predetermined image.

19. The input system as claimed in claim 18, wherein the determining unit determines whether or not the cursor continuously overlaps with the predetermined image during a predetermined time.

20. The input system as claimed in claim 18, wherein the arranging unit moves the predetermined image, and
wherein the determining unit determines whether or not the cursor comes in contact with or overlaps with the moving predetermined image under satisfaction of a predetermined requirement.

21. An input method comprising the steps of:
generating a video image; and
controlling the video image,
wherein the step of controlling including;
an analysis step of obtaining a position of a subject on the basis of a photographed picture obtained by a photographing unit which photographs the subject in real space, the subject being operated by a player on a screen placed in the real space; and
a cursor control step of making a cursor follow the subject on the basis of the position of the subject obtained by the analysis step,
wherein the cursor control step including:
a correction step of correcting a position of the cursor so that the position of the subject in the real space coincides with the position of the cursor in the video image projected onto the screen, on the screen in the real space.

22. An input method comprising the steps of:
generating a video image including a cursor; and
controlling the video image;
wherein the step of controlling including:
an analysis step of obtaining a position of a subject on the basis of a photographed picture obtained by a photographing unit which is installed so that an optical axis is oblique with respect to a plane to be photographed, and photographs the subject on the plane to be photographed,
a keystone correction step of applying keystone correction to the position of the subject obtained by the analysis step; and
a cursor control step of making the cursor follow the subject on the basis of a position of the subject after the keystone correction.

23. A computer program for enabling a computer to perform the input method as claimed in claim 21 or 22.

24. A computer readable recording medium embodying the computer program as claimed in claim 23.
